(19) United States
(12) Patent Application Publication
(10) Pub. No.: US 2008/0109332 A1
(43) Pub. Date: May 8, 2008

(54) METHODS, SYSTEMS, AND COMPUTER PROGRAM PRODUCTS FOR IMPLEMENTING GLOBAL EXCHANGE SERVICES

(76) Inventors: Thomas Margarido, Willington, CT (US); Jason Margarido, Ellington, CT (US); Paul K. Taff, Andover, CT (US)

Correspondence Address: CANTOR COLBURN, LLP, 20 Church Street, 22nd Floor, Hartford, CT, 06103, US

(21) Appl. No.: 11/747,385

(22) Filed: May 11, 2007

Related U.S. Application Data
(60) Provisional application No. 60/812,802, filed on Jun. 12, 2006.

(51) Int. Cl. G06Q 40/00; G06Q 30/00

(52) U.S. Cl. 705/34; 705/35; 705/40

(57) ABSTRACT

A method, system, and computer program product for implementing global exchange services is provided. The method includes establishing a network-based communications hub for exchange service entities. The communications hub is established by classifying the exchange service entities by client and client vendor, determining a subscription status identifier for the client and the client vendor, and grouping the client and the client vendor by geography. The communications hub is further established by specifying access and capability privileges for each of the exchange service entities, and establishing accounting preferences, service fees, and service definitions and instructions for services provided by the exchange service entities. The method also includes enabling communications among selected exchange service entities via administrative permissions established resulting from the access and capability privileges specified for each of the exchange service entities.

### BACKGROUND OF THE INVENTION

This application claims priority to U.S. Provisional Application No. 60/812,802, filed on Jun. 12, 2006, the contents of which are incorporated by reference herein in its entirety

The present disclosure relates generally to electronic exchange services and, in particular, to methods, systems, and computer program products for implementing global exchange services through a centralized network hub.

Continuous advancements made in the fields of Internet technologies and related communications technologies have steadily paved the way for a variety of new and useful inter- and intra-enterprise solutions. In order to stay competitive, business enterprises must keep abreast of these advancements and utilize them to seek out ways to improve various business functions in order to reduce costs and provide the most value to customers.

Most business enterprises rely upon, and collaborate with, third parties (e.g., trading partners, suppliers, manufacturers, outsourced entities, etc.) to conduct business and realize goals. Advancements in Internet technologies, such as open source protocols, have enabled communications among these parties that were never before possible due to, e.g., disparate legacy systems.

Despite these advancements, however, many business enterprises find that flexible and scalable solutions that fully address their unique business needs are still lacking. Each business partner in a collaborative business relationship has different business interests and requirements. For example, an original equipment manufacturer may focus on integrating supply chain activities among its suppliers and contract manufacturers in order to meet manufacturing deadlines, while a contract manufacturer of the OEM may be focused on meeting not only its responsibilities to the OEM, but also various other OEMs for which it has entered into a contract relationship. Thus, each entity in a collaborative business environment may have its own unique needs and perspectives.

What is needed, therefore, is a solution that facilitates interactions among a number of collaborative entities and which addresses the unique interests and requirements of each entity.

### BRIEF SUMMARY OF THE INVENTION

Exemplary embodiments of the invention include methods, systems, and computer program products for implementing network-based global exchange services. The method includes establishing a communications hub for exchange service entities. The communications hub is established by classifying the exchange service entities by client and client vendor, determining a subscription status identifier for the client and the client vendor, and grouping the client and the client vendor by geography. The communications hub is further established by specifying access and capability privileges for each of the exchange service entities, and establishing accounting preferences, service fees, and service definitions and instructions for services provided by the exchange service entities. The method also includes enabling communications among selected exchange service entities via administrative permissions established resulting from the access and capability privileges specified for each of the exchange service entities.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a system upon which the global exchange services may be implemented in exemplary embodiments;

FIG. 2 is a computer screen window depicting a sample main menu for launching various functions provided by the global exchange services in exemplary embodiments;

FIG. 3 is a flow diagram describing a process for implementing the global exchange services in exemplary embodiments; and

FIGS. 4-77 depict sample computer screen windows for implementing the global exchange services in exemplary embodiments.

The detailed description explains the exemplary embodiments of the invention, together with advantages and features, by way of example with reference to the drawings.

### DETAILED DESCRIPTION OF THE INVENTION

Global exchange services are provided in accordance with exemplary embodiments. The global exchange services facilitate interactions among a number of collaborative entities and assist in addressing the unique interests and requirements of each entity via a secure communications hub. The global exchange services described herein may be utilized for a variety of industries. The global exchange services are particularly useful in an industry that utilizes field services (e.g., remote field technicians). For purposes of illustration and ease of explanation, the global exchange services will be described with respect to the property preservation and inspection services, or distressed property services. The distressed property services sector typically facilitates maintenance, inspection, and repair of properties subject to, or under, foreclosure by a lender or mortgage loan servicing enterprise. In this example, various inter-enterprise parties may participate in the global exchange services, such as mortgage lenders or loan servicing entities, property preservation and inspection service providers, and insurance companies, to name a few.

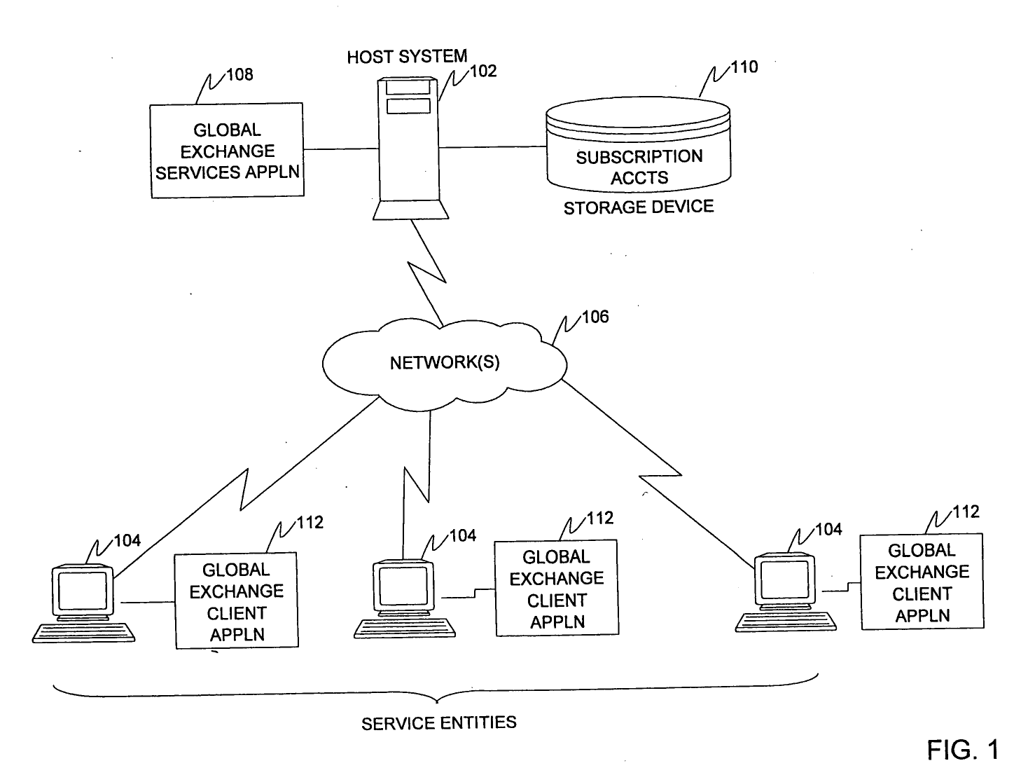

Turning now to FIG. 1, a system upon which the global exchange services may be implemented in accordance with exemplary embodiments will now be described. The system of FIG. 1 includes a host system 102 in communication with service entities 104 over one or more networks 106. Host system 102 may be implemented by, e.g., an application service provider (ASP) that provides and administers global exchange services for subscribing entities. Host system 102 may be implemented using one or more servers operating in response to a computer program stored in a storage medium accessible by the server(s). The host system 102 may operate as a network server (e.g., a web server) to communicate with the service entities 104. The host system 102 handles sending and receiving information to and from the service entities 104 and can perform associated tasks. The host system 102 executes one or more applications (e.g., global exchange services application 108) to provide the services described herein.

Service entities 104 include subscribers of the global exchange services provided by host system 102. Service entities 104 may be situated in widely remote locations around the globe. Subscribers refer to those individuals and/or entities that subscribe (e.g., register) to receive and participate in the global exchange services provided by the host system 102 as described further herein. Service entities 104 may be implemented using a general-purpose computer executing a computer program for carrying out at least a portion of the processes described herein. The service entities 104 may be personal computers that are implemented in a wireline or wireless fashion (e.g., a lap top, a personal digital assistant, tablet PC, etc.) or host attached terminals. If the service entities 104 are personal computers, the processing described herein may be shared by a service entity 104 and the host system 102 (e.g., by providing an applet to the service entity 104). Alternatively, a portion of the processing described herein may be performed via a client application executing on the service entity 104 (e.g., global exchange client application 112).

One or more service entities 104 may comprise a single client or subscriber entity with respect to the global exchange services. For example, one service entity may be implemented as a remote computer device (e.g., a tablet PC) that provides field services (e.g., home inspections, repairs, maintenance, etc.) for another service entity (e.g., a property preservation enterprise). In this example host system 102, acting as a hub system, may receive work orders or other information that is targeted for the remote service entity. Since the remote service entity may not enjoy consistent, reliable network connectivity (or alternatively, may not be network-enabled at all), the host system 102 stores this information and forwards it to the remote service entity when the remote service entity, or related network-enabled service entity, connects to the host system 102. This ‘store-and-forward’ feature of the global exchange services also provides information protection and integrity where various network issues prevent service entities 104 from connecting to each other or the host system 102; that is, irrespective of whether remote service entities are employed.

While only three service entities 104 are shown in the system of FIG. 1, it will be understood that many service entities 104 may be implemented in order to realize the advantages of the global exchange services.

The host system 102 is in communication with a storage device 110. Storage device 110 may be implemented using memory contained in the host system 102 or it may be a separate physical device. In exemplary embodiments, the storage device 110 is in direct communication with the host system 102 (via, e.g., cabling). However, other network implementations may be utilized. For example, storage device 110 may be logically addressable as a consolidated data source across a distributed environment that includes one or more networks 106. Information stored in the storage device 110 may be retrieved and manipulated via the host system 102. Storage device 110 stores a variety of information for use in implementing the global exchange services. As shown in FIG. 1, storage device 110 stores subscriber account records. Subscriber account records may include information regarding subscribers of the services (e.g., identification information, notification means, such as IP routing addresses, email addresses, etc., for subscriber service entities 104).

Network(s) 106 may be any type of known network including, but not limited to, a wide area network (WAN), a local area network (LAN), a global network (e.g. Internet), a virtual private network (VPN), and an intranet. The network(s) 106 may be implemented using a wireless network or any kind of physical network implementation known in the art. A service entity 104 may be coupled to the host system 102 through multiple networks (e.g., intranet and Internet) so that not all service entities 104 are coupled to the host system 102 through the same network. In one embodiment, the network is an intranet and one or more service entities 104 execute a user interface application (e.g. a web browser) to contact the host system 102 through the network 106 while another service entity 104 may be directly connected to the host system 102. In another exemplary embodiment, the service entity 104 is connected directly (i.e., not through the network 106) to the host system 102 (not shown) and the host system 102 is connected directly to or contains the storage device 110. One or more of the service entities 104 and the host system 102 may be connected to the network 106 in a wireless fashion.

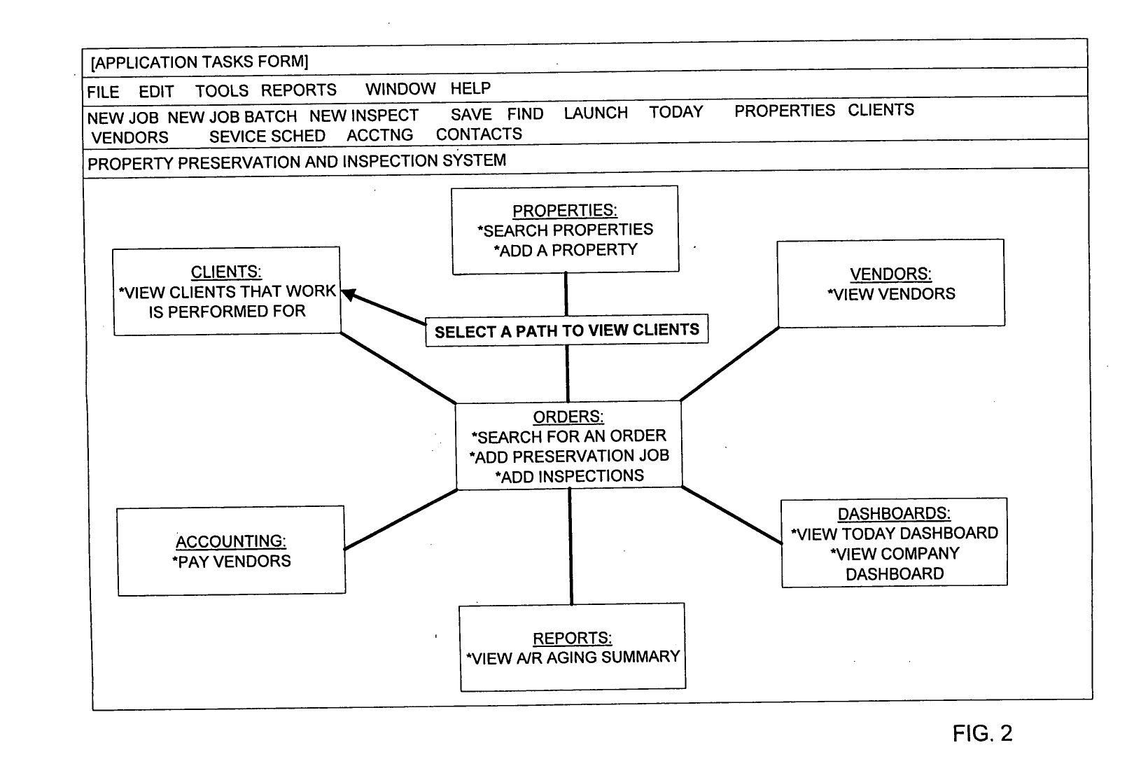

The global exchange services facilitated through the application 108 and/or client application 112 provide a common user interface from which various functions may be launched (i.e., a single point of reference). The functions available for each particular subscriber (e.g., service entities 104) via the user interface may be customized based upon each subscriber's unique interests and requirements. Using the above-referenced property preservation and inspection services implementation, e.g., subscribers may include mortgage lenders, loan servicing entities, insurance companies, contract property preservation and/or inspection service providers, etc. A sample computer screen window provided by the global exchange services is shown and described in FIG. 2. By selecting one or more options provided in the computer screen window 200, a subscribing entity (e.g., service entity 104) can initiate the features and functions available by the global exchange services described herein.

Features and functions provided by the global exchange services include by way of non-limiting examples: setting up, modifying, and removing clients and client vendors for a communications hub; distinguishing subscribing entities from non-subscribing entities; grouping entities by geography, establishing privileges (e.g., access and capabilities) for users of the exchange services; establishing preferences for accounting processes and service fees/payments; defining services and instructions; and enabling/disabling communications among various entities participating in a global exchange communications hub.

It will be understood that multiple communications hubs may be established for a group of entities, whereby each grouping represents a single communications hub. Each communications hub, then, operates and exists independently of other communications hubs. A communications hub may be defined as a network of entities that provides services and/or is serviced by selected members of the hub to which these members belong. The members of the communications hub communicate with one another through the hub (e.g., over one or more networks 106).

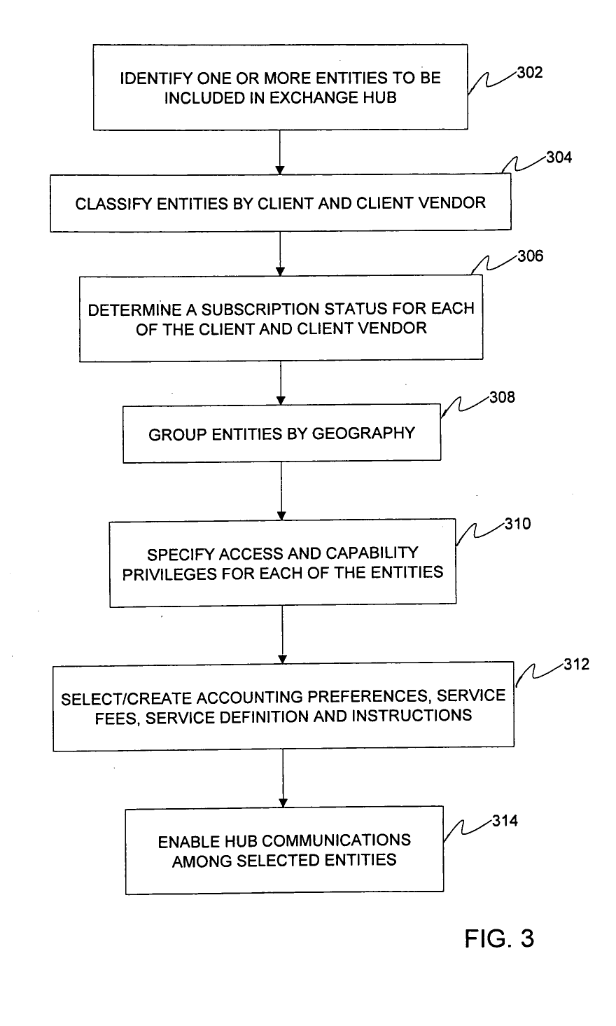

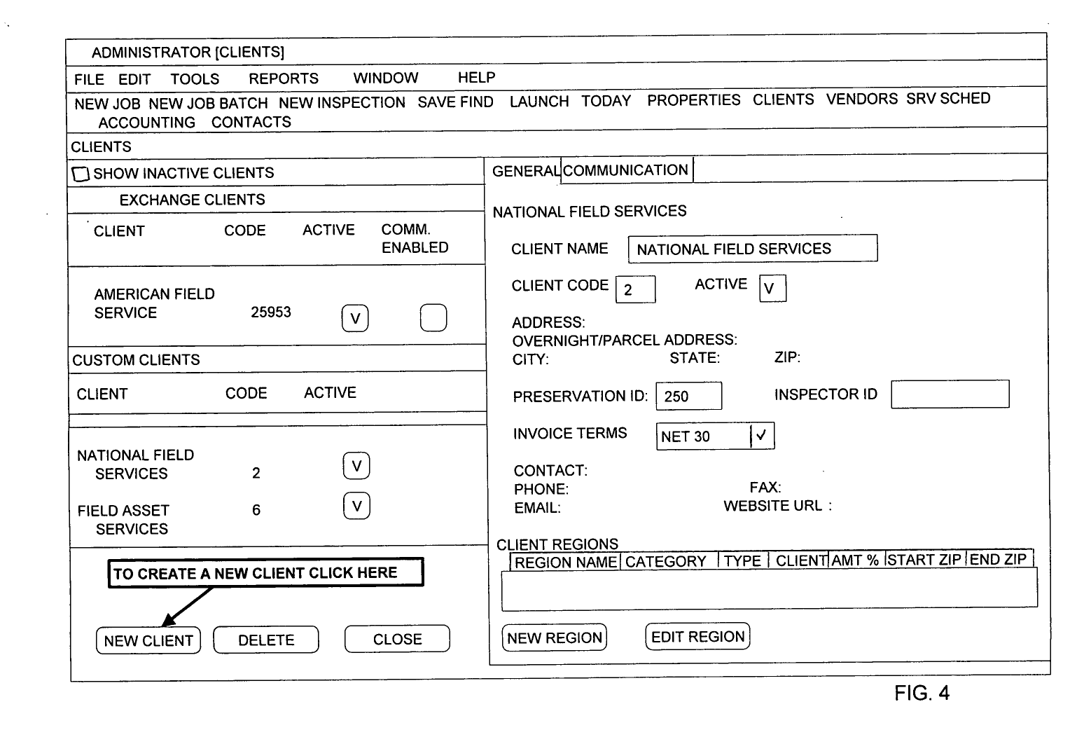

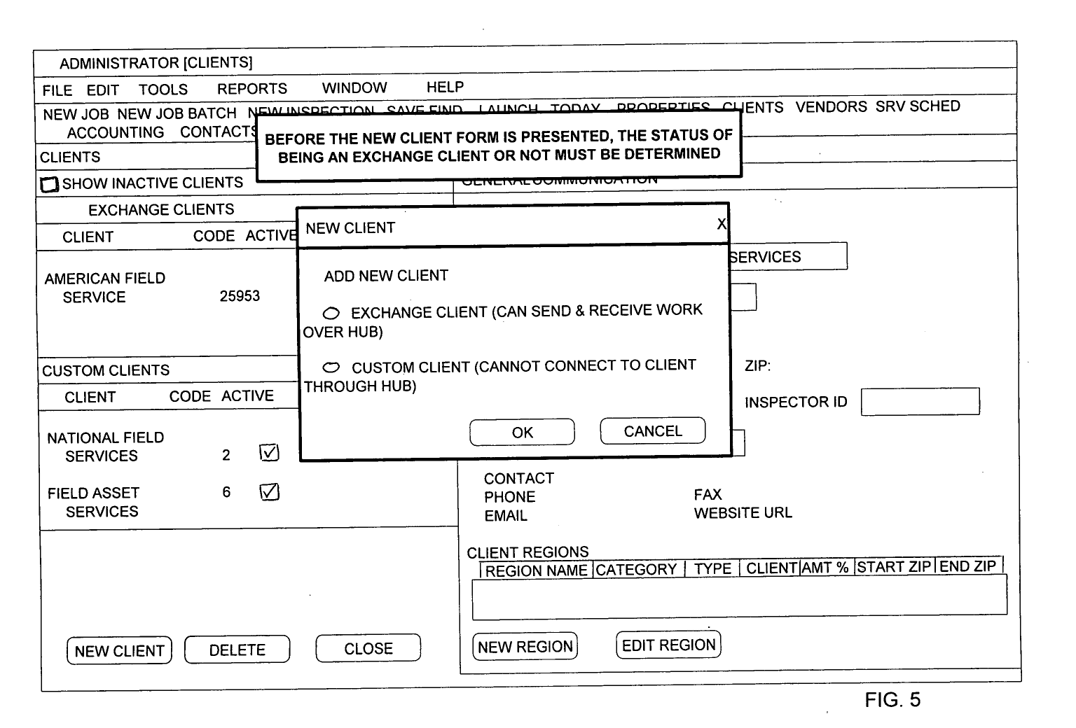

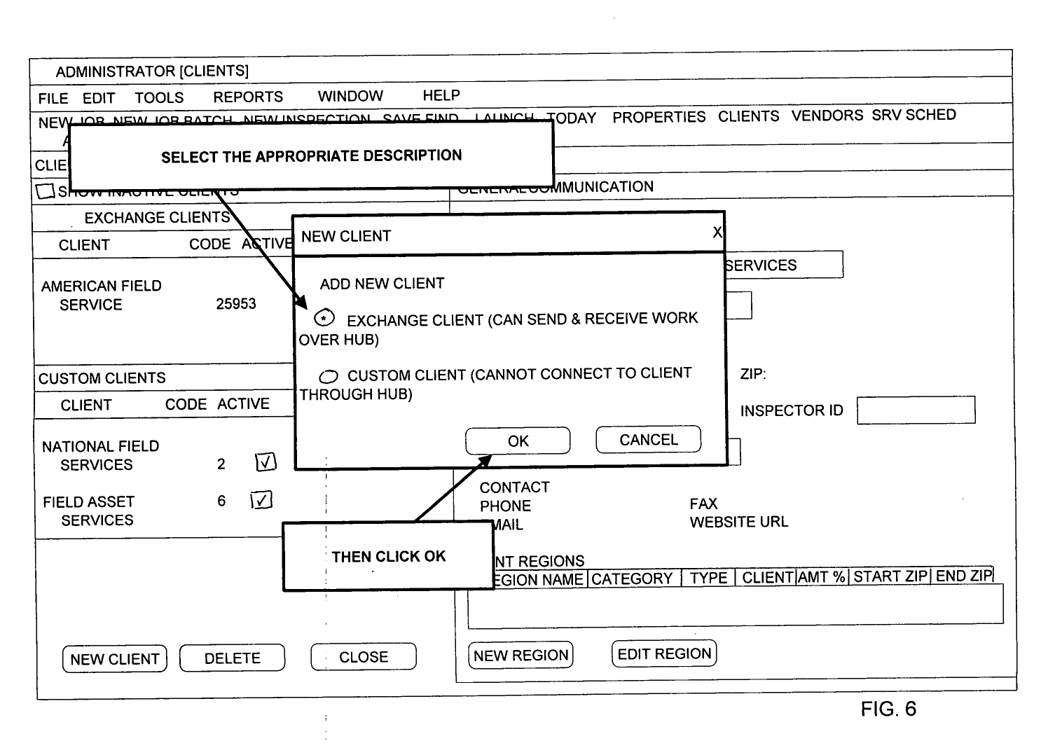

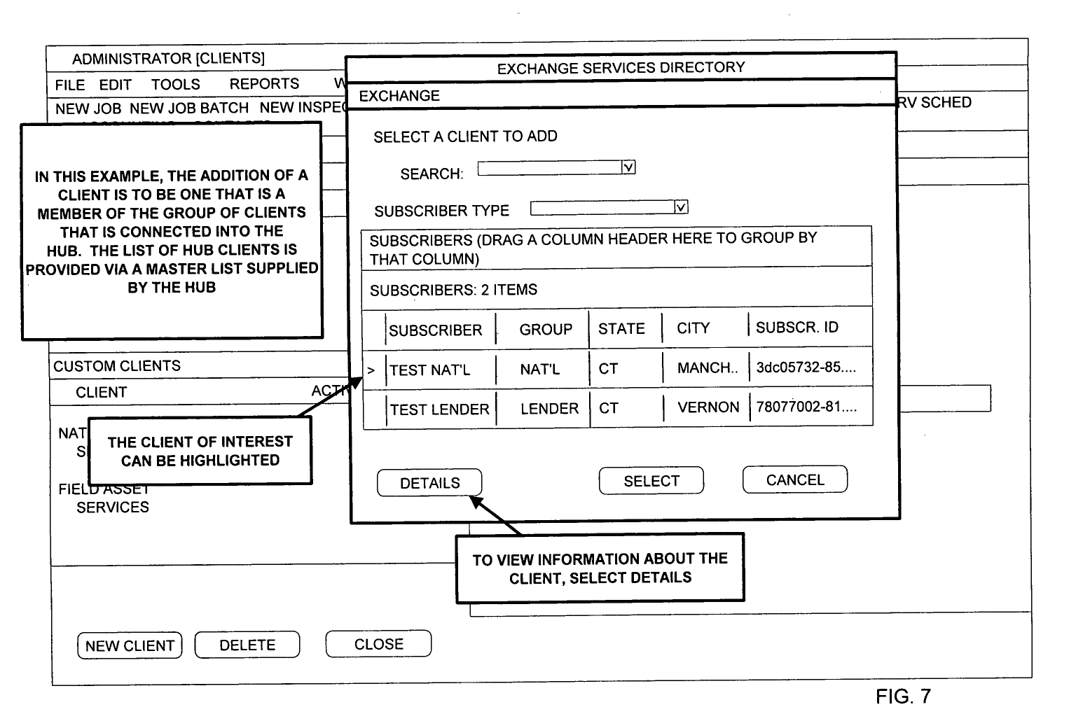

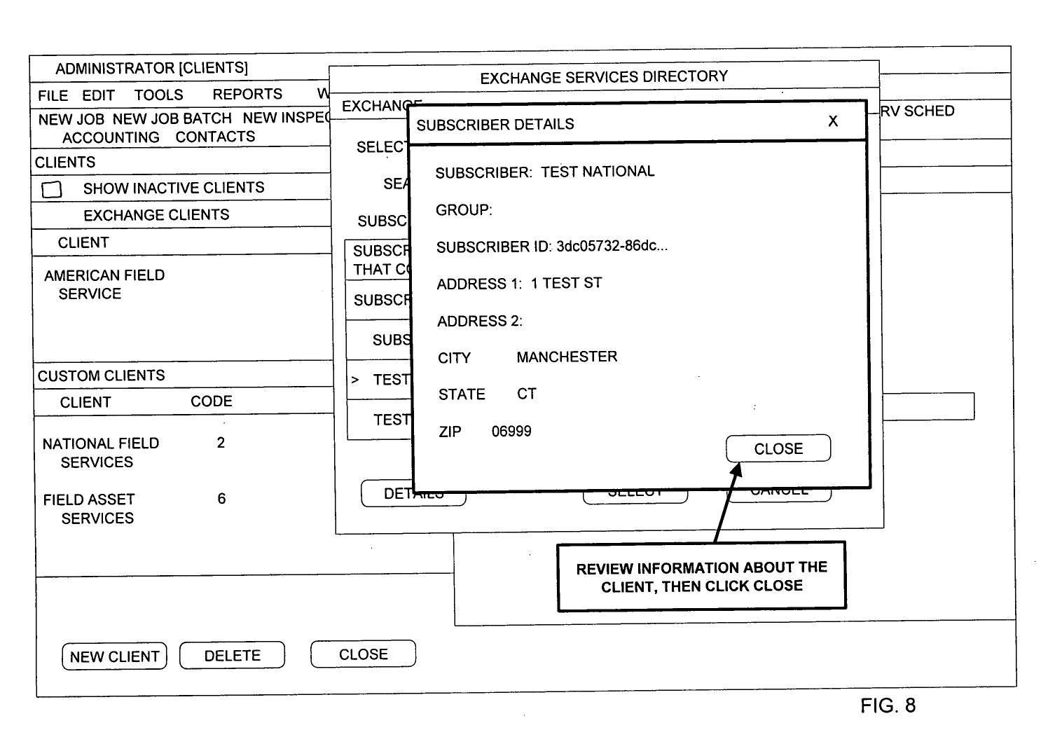

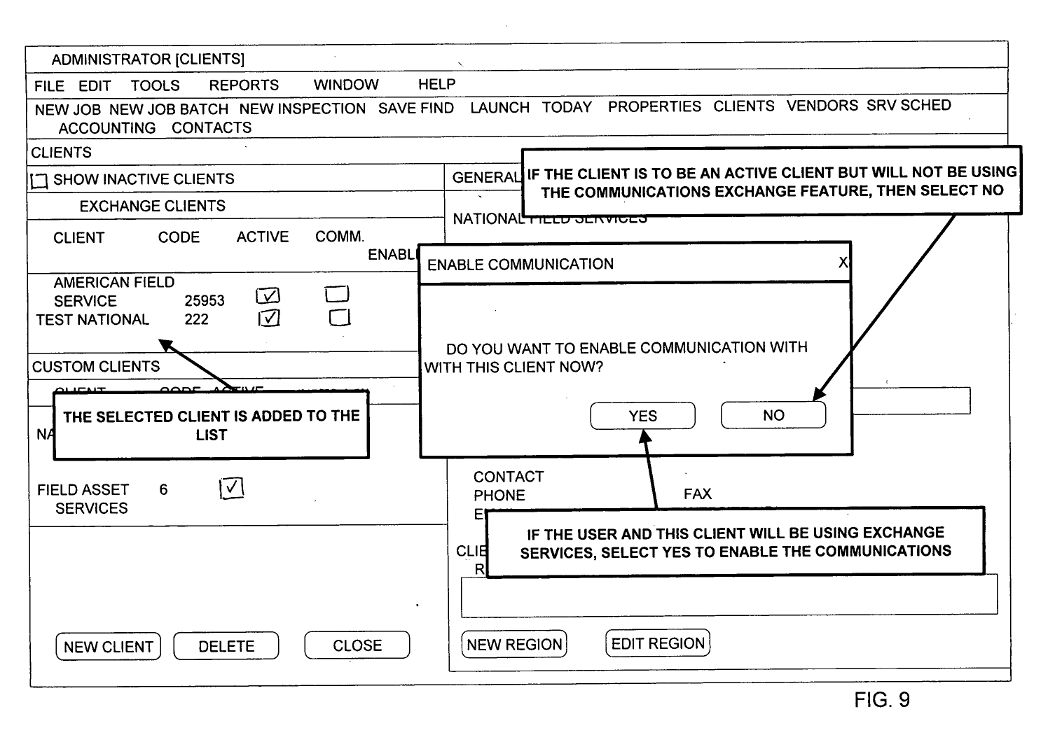

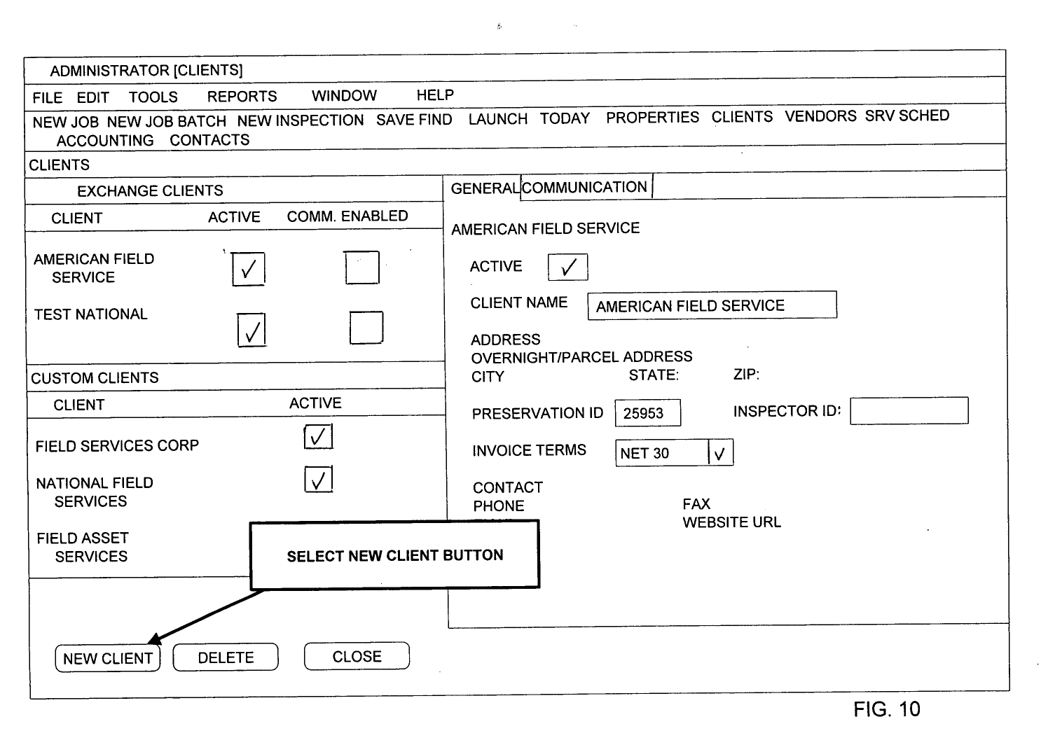

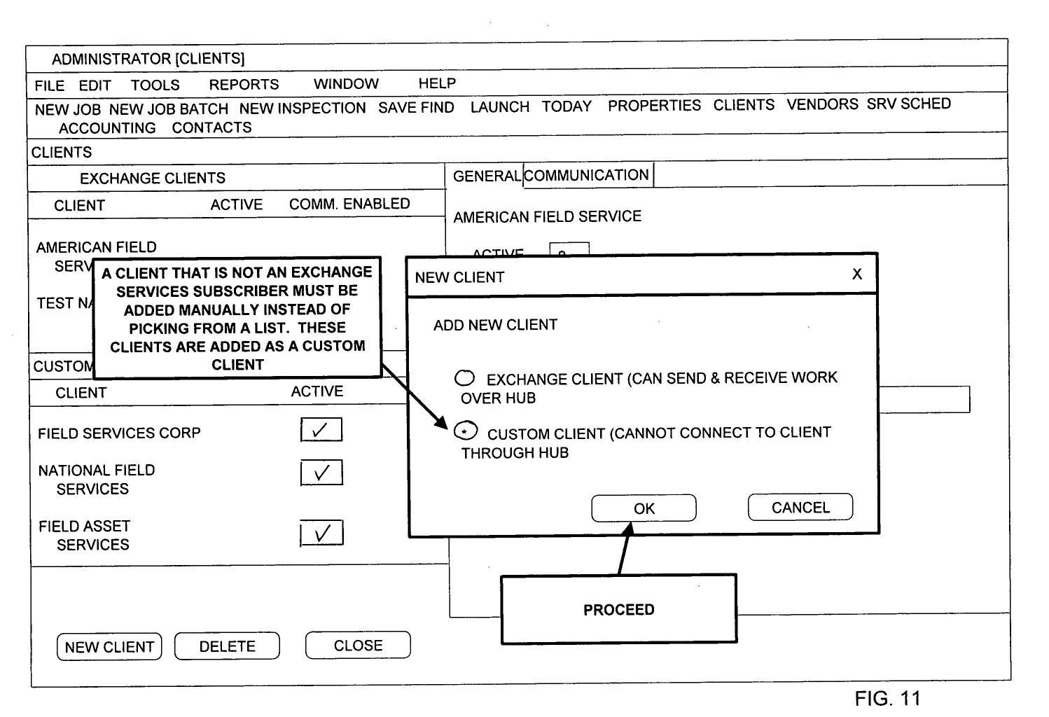

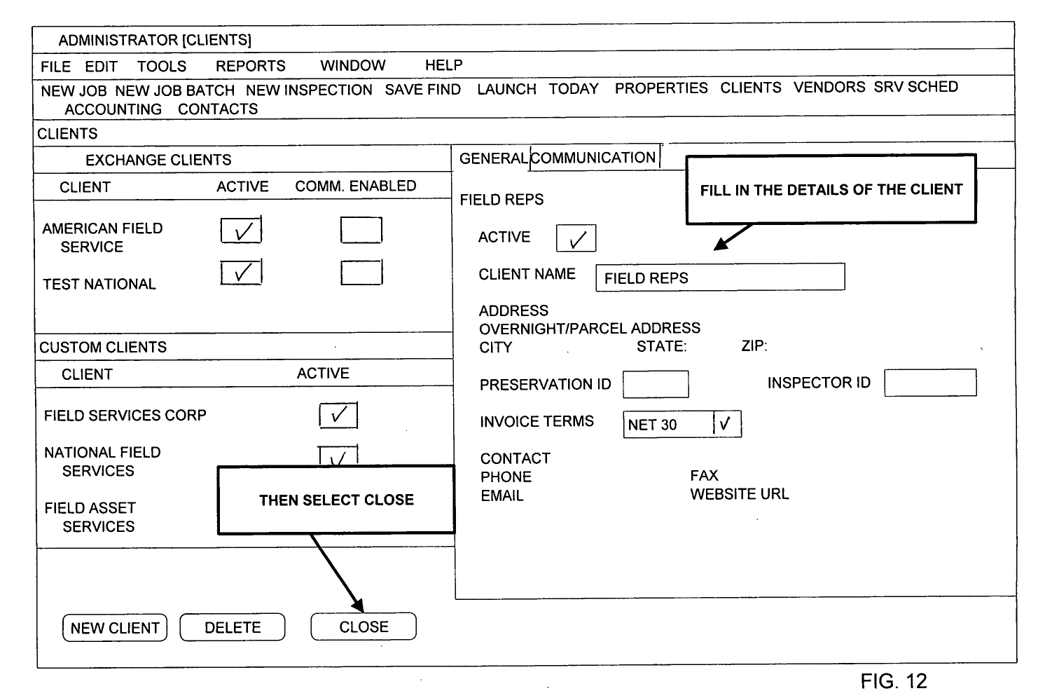

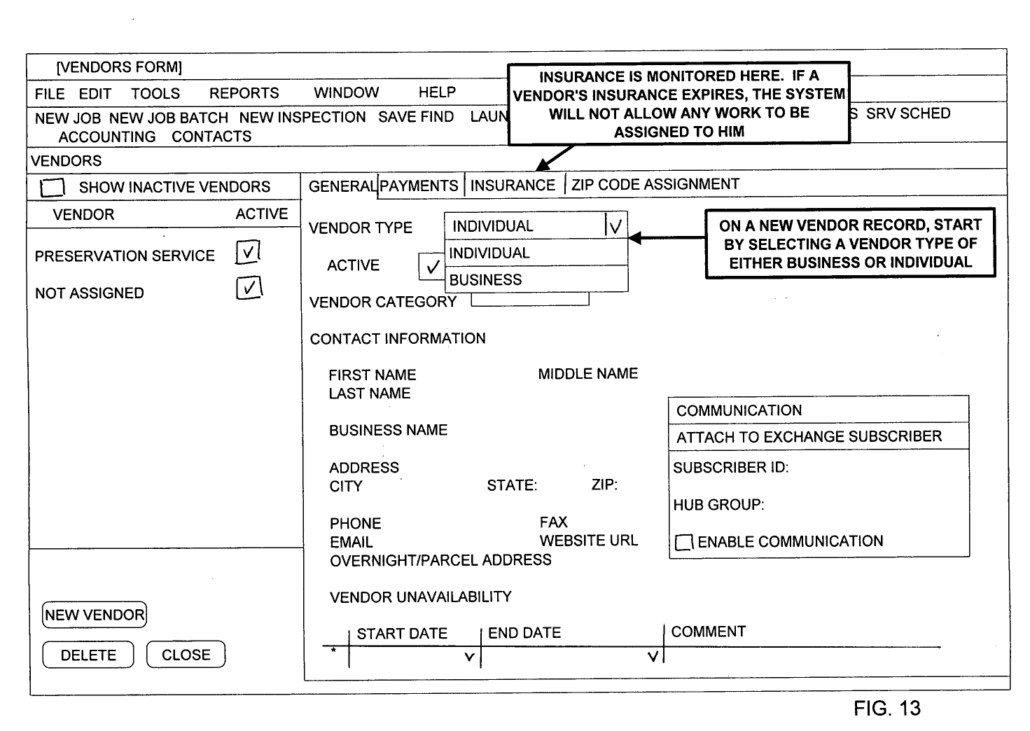

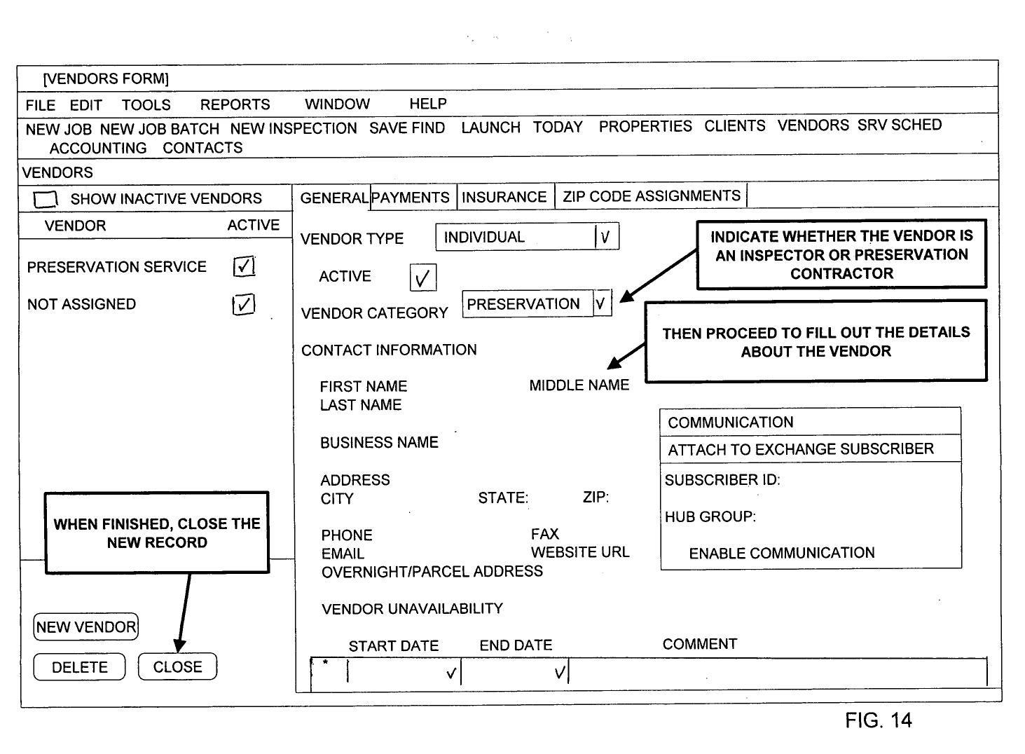

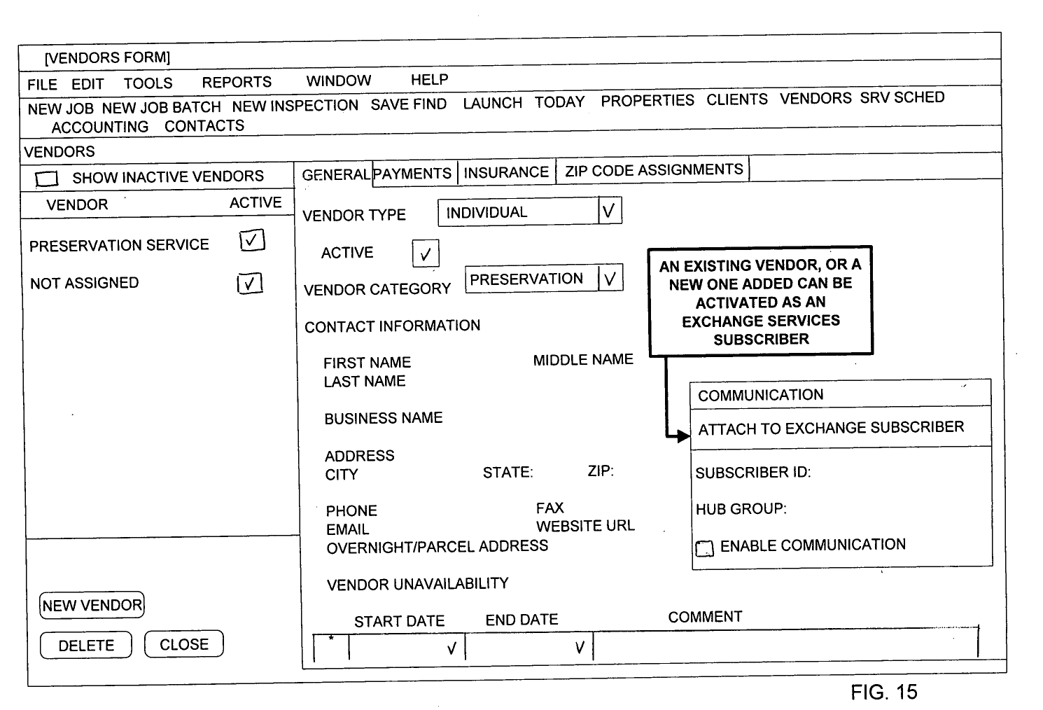

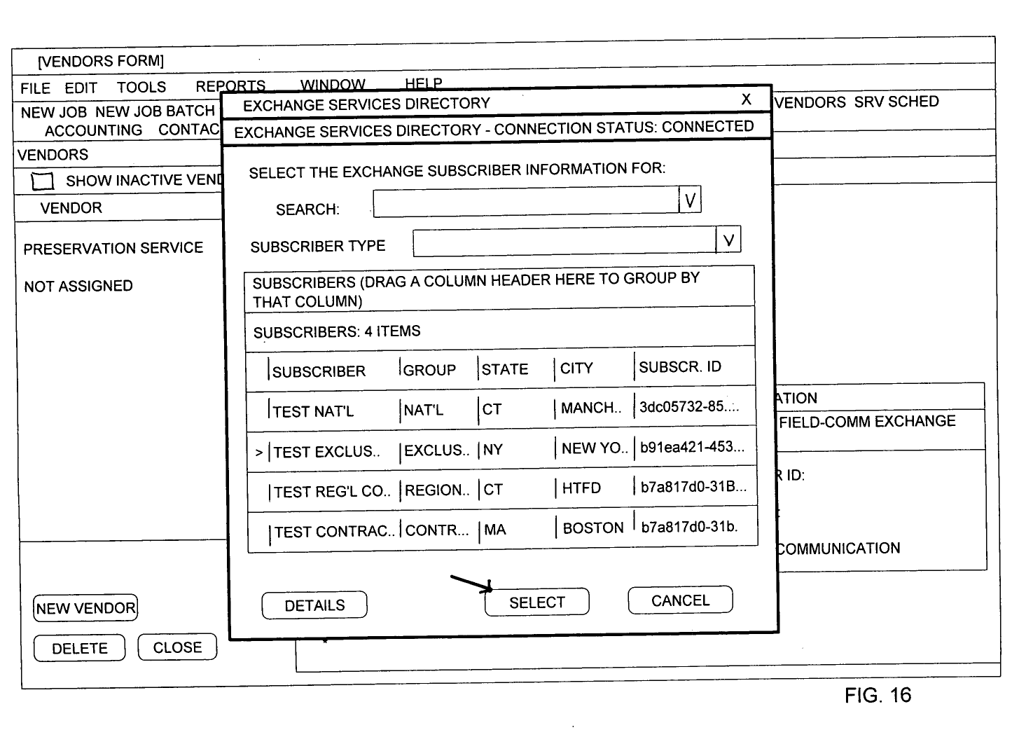

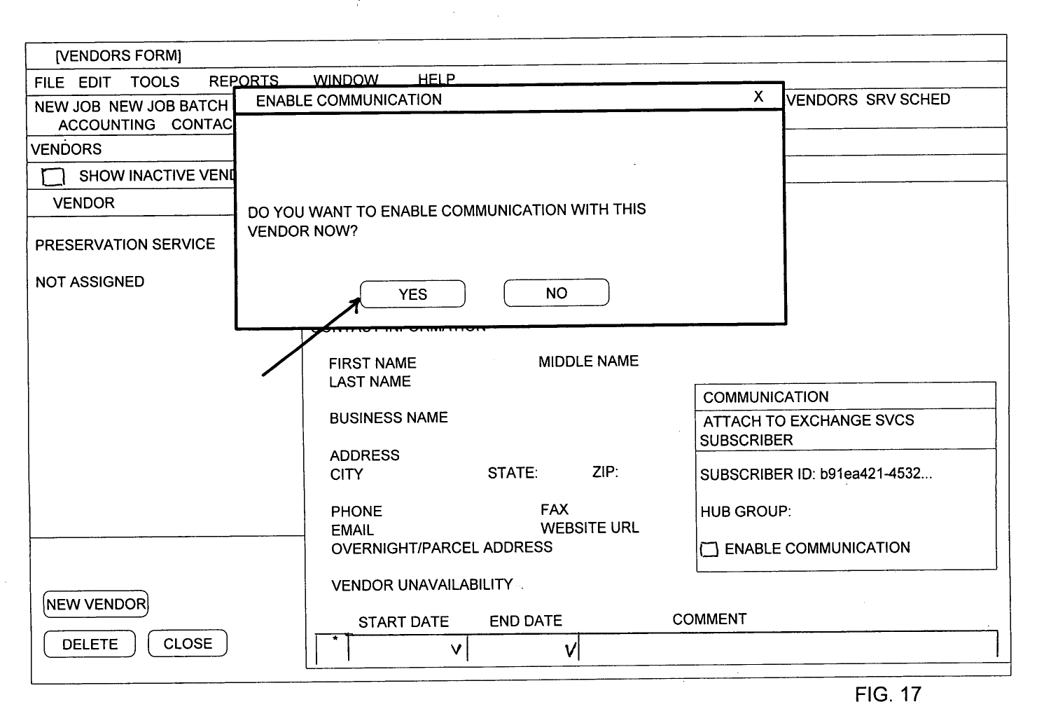

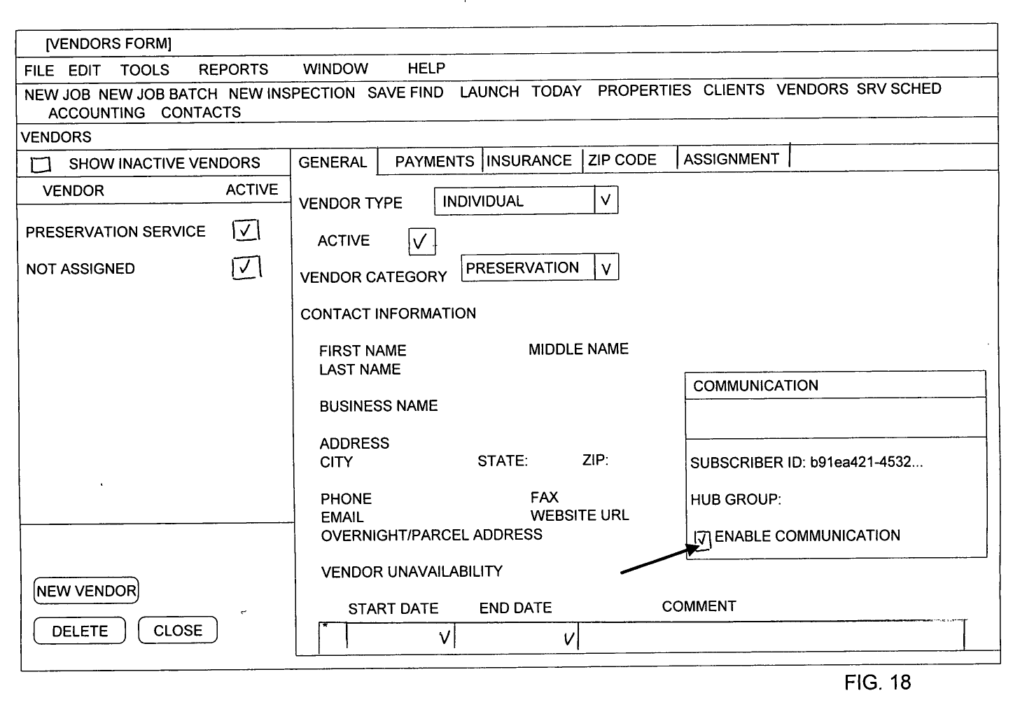

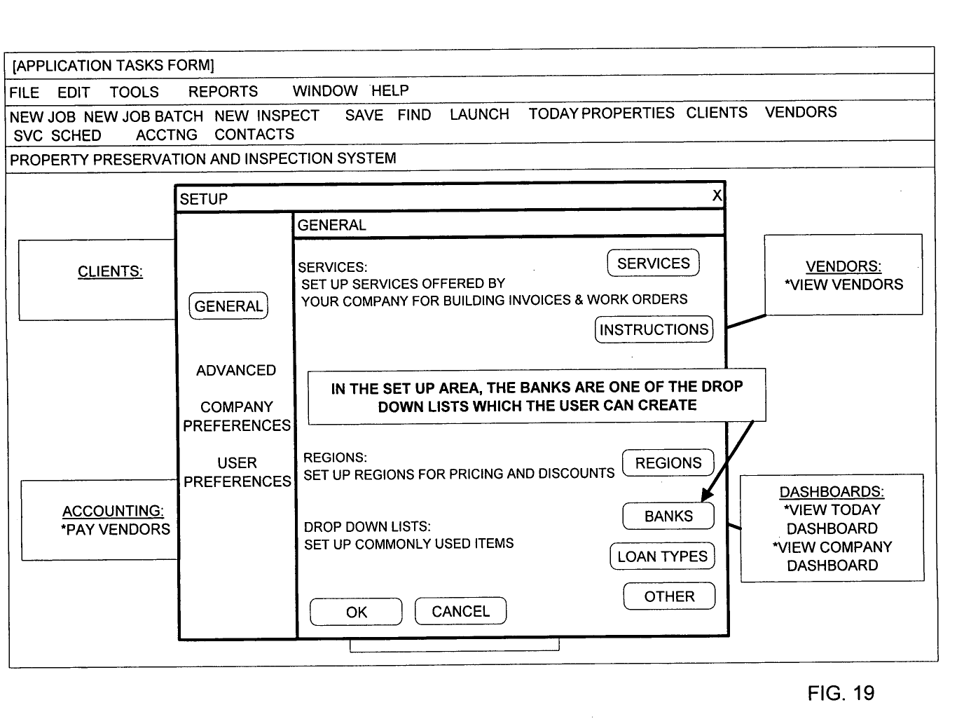

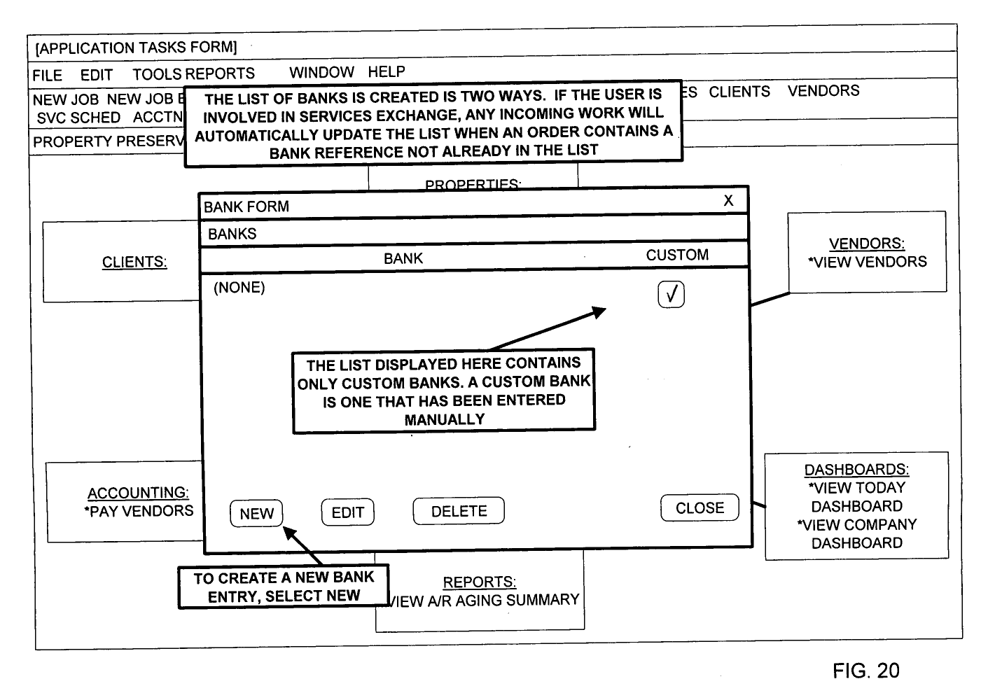

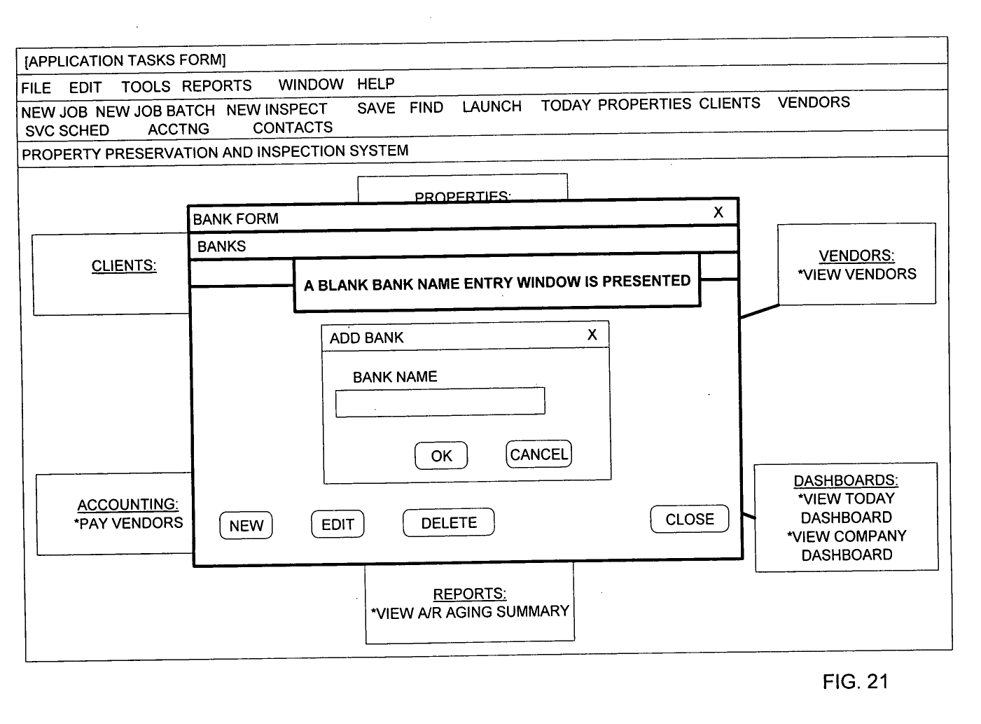

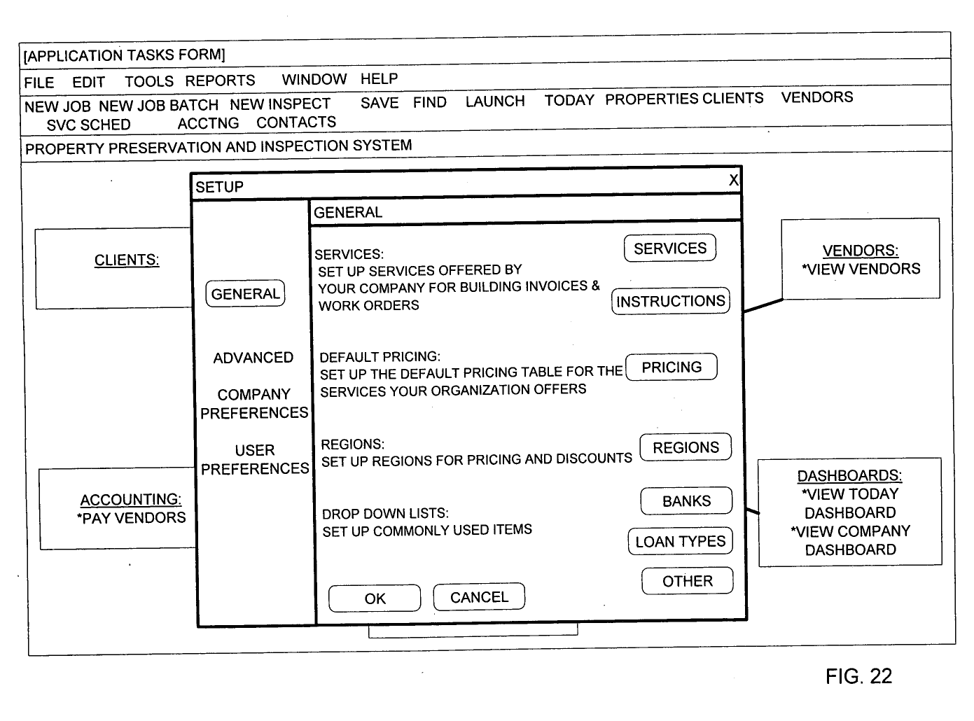

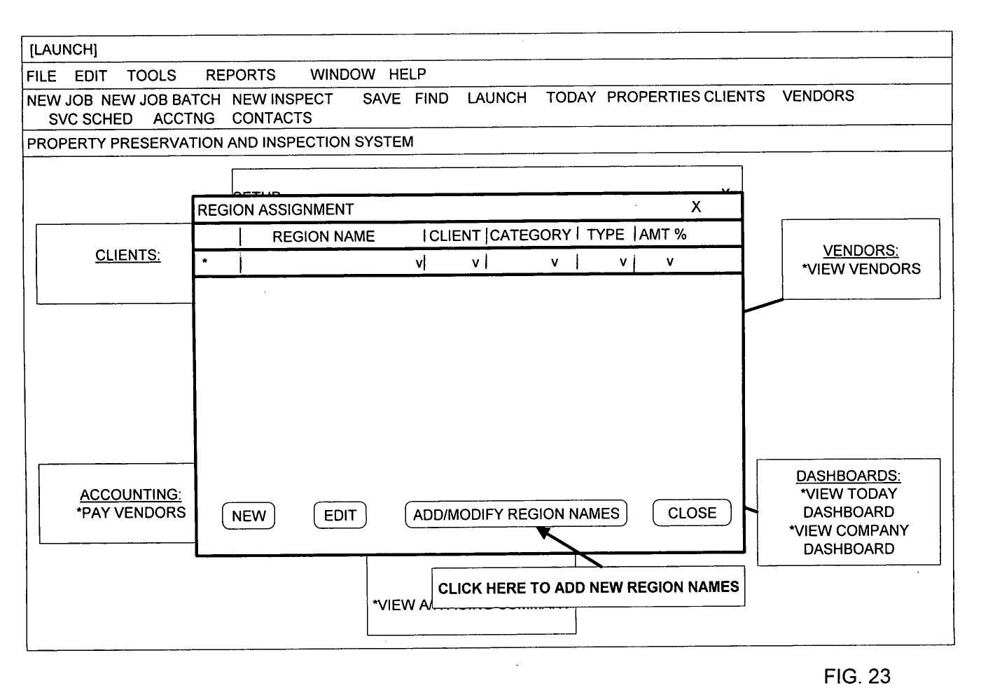

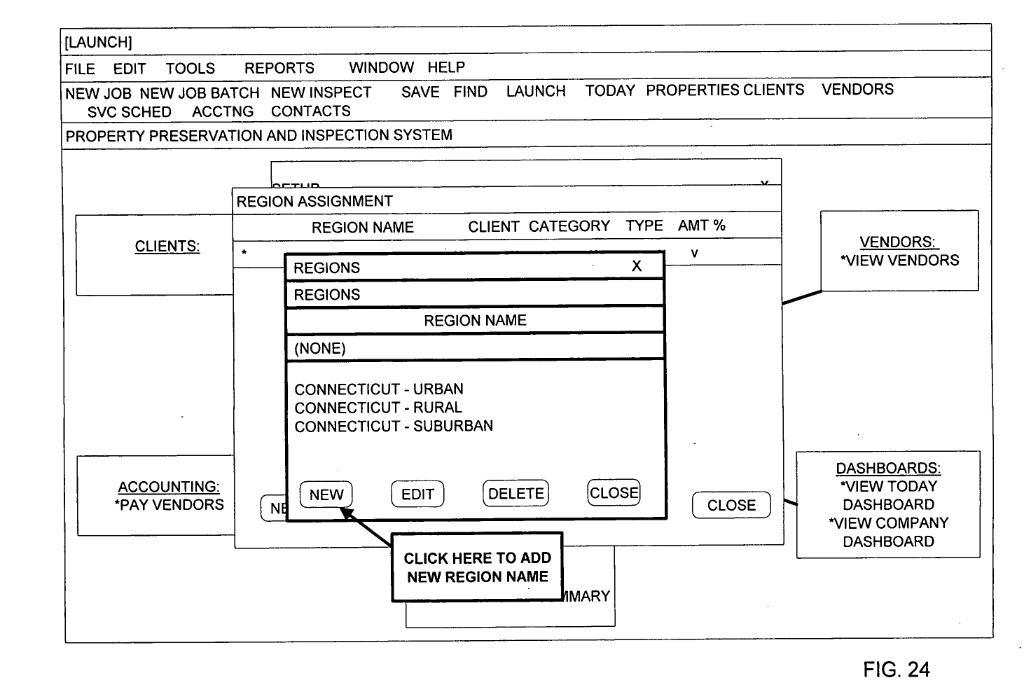

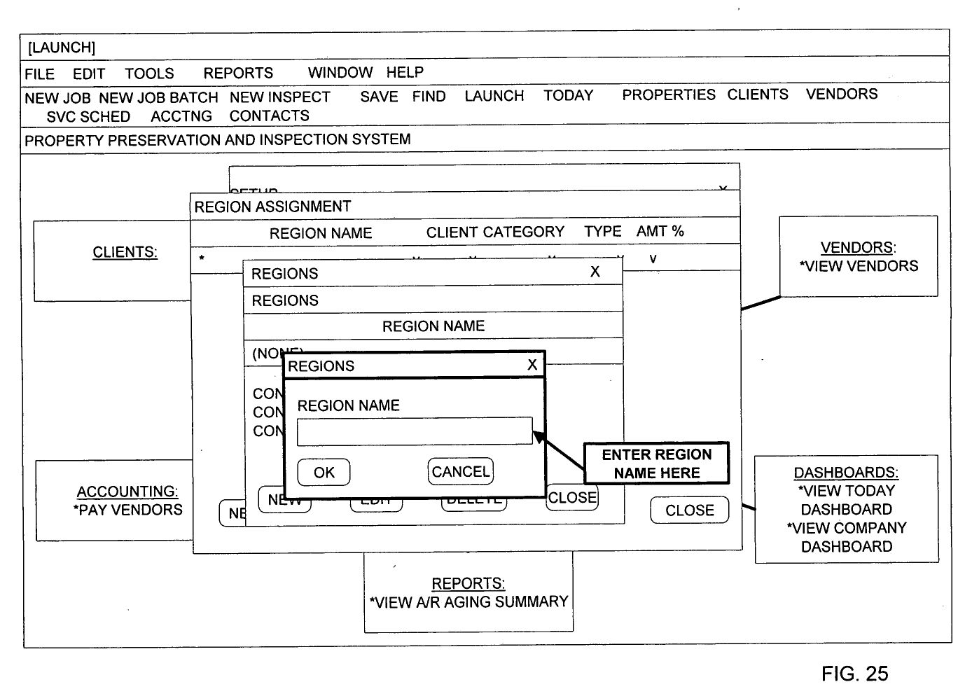

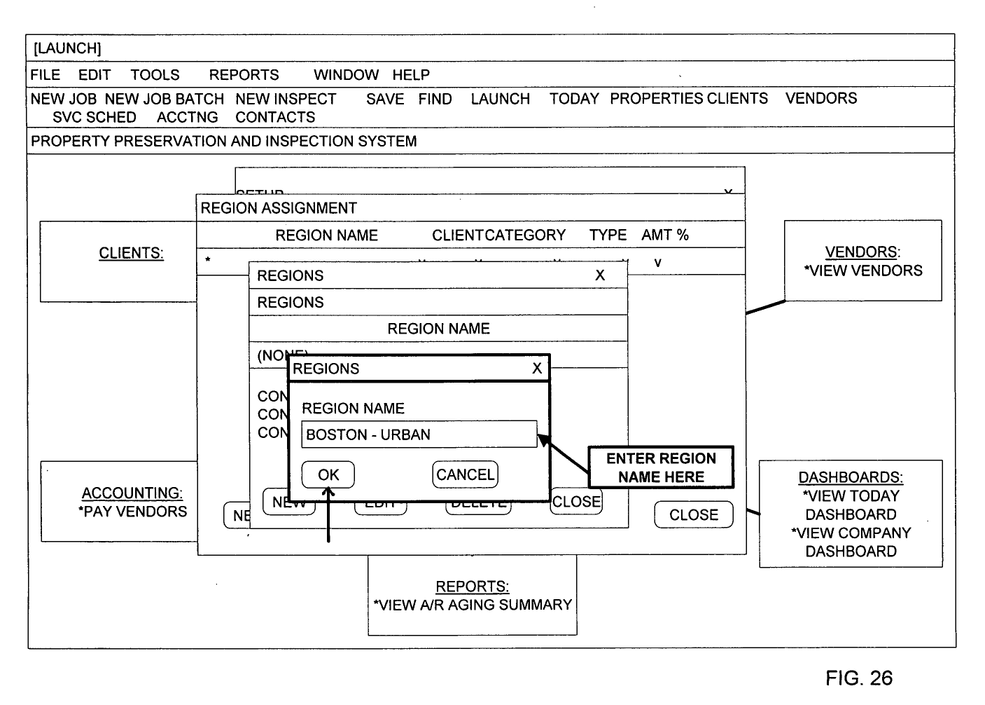

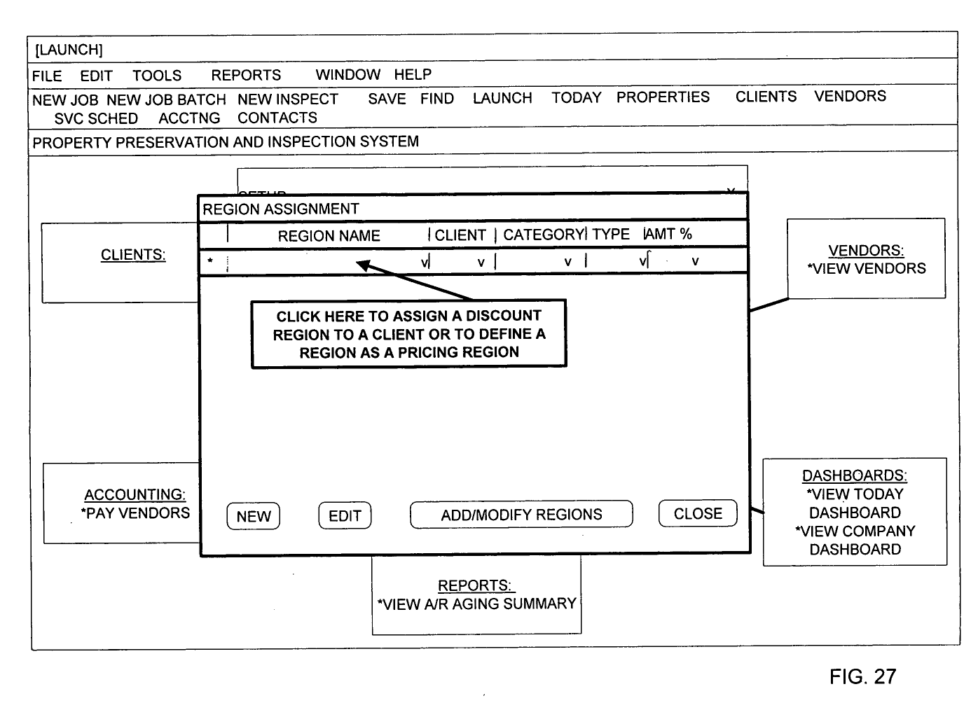

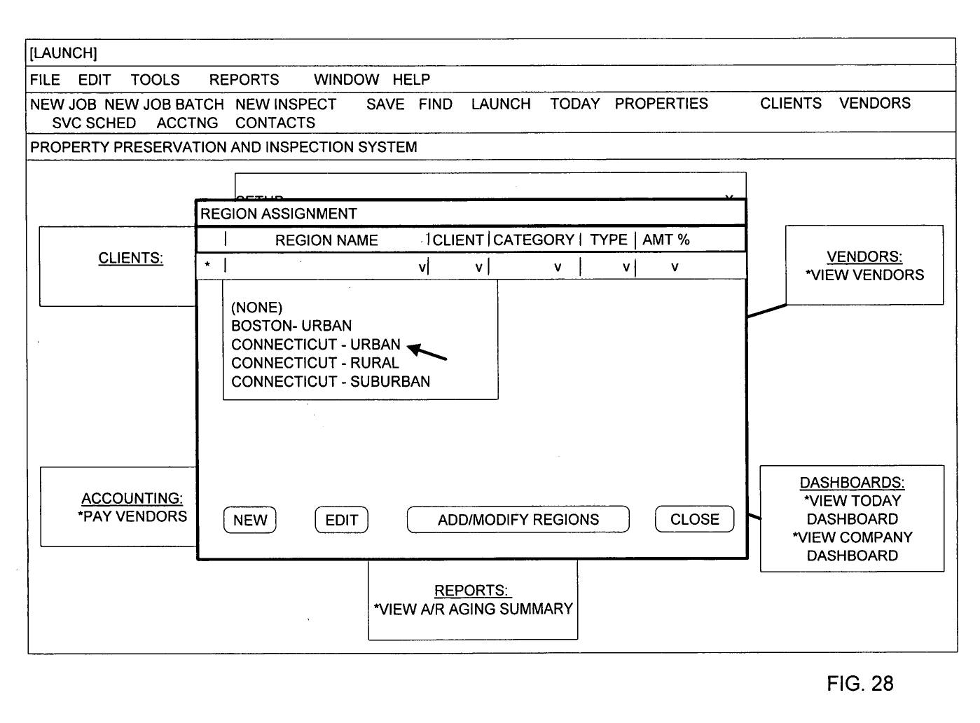

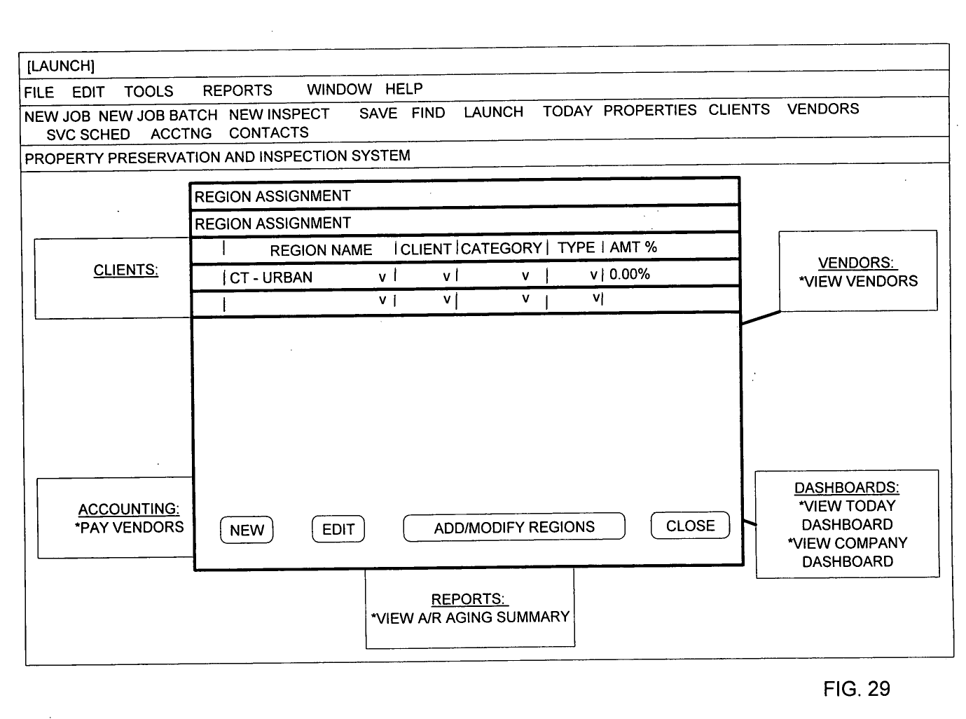

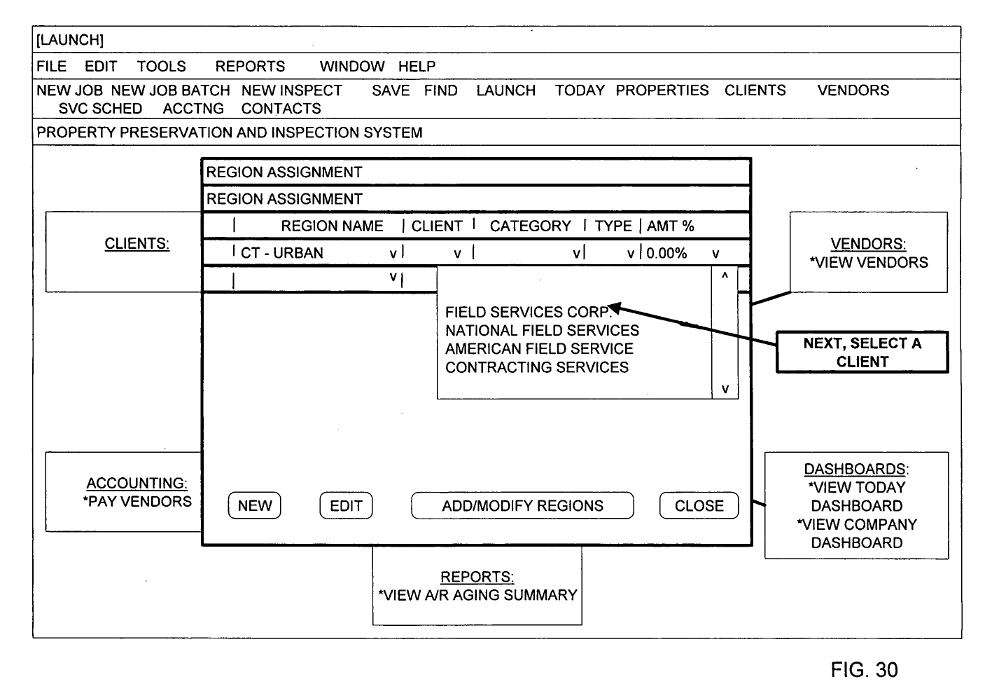

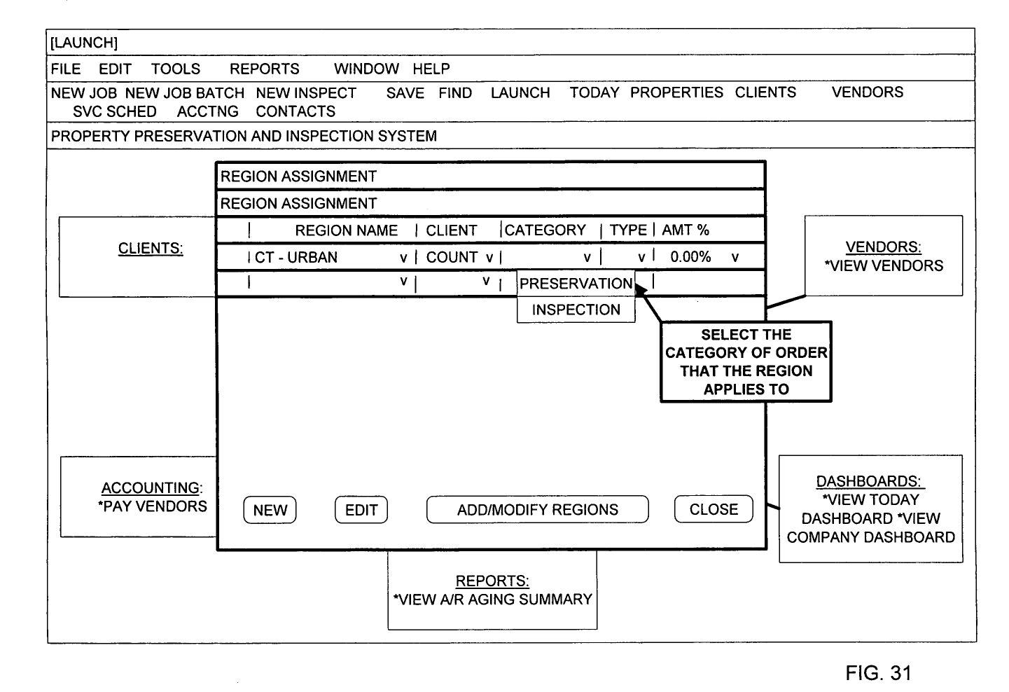

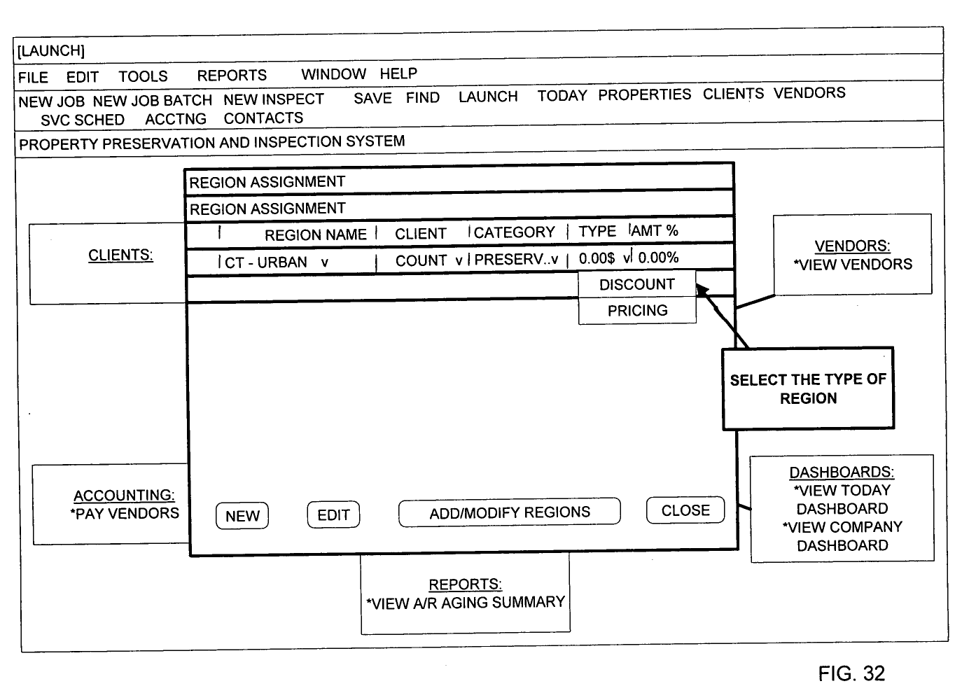

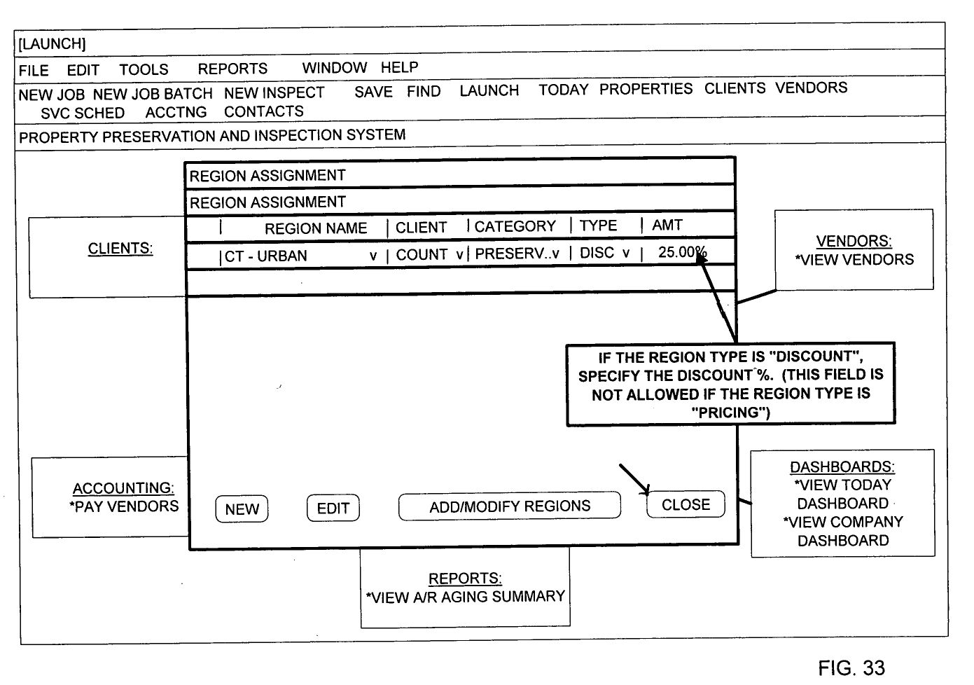

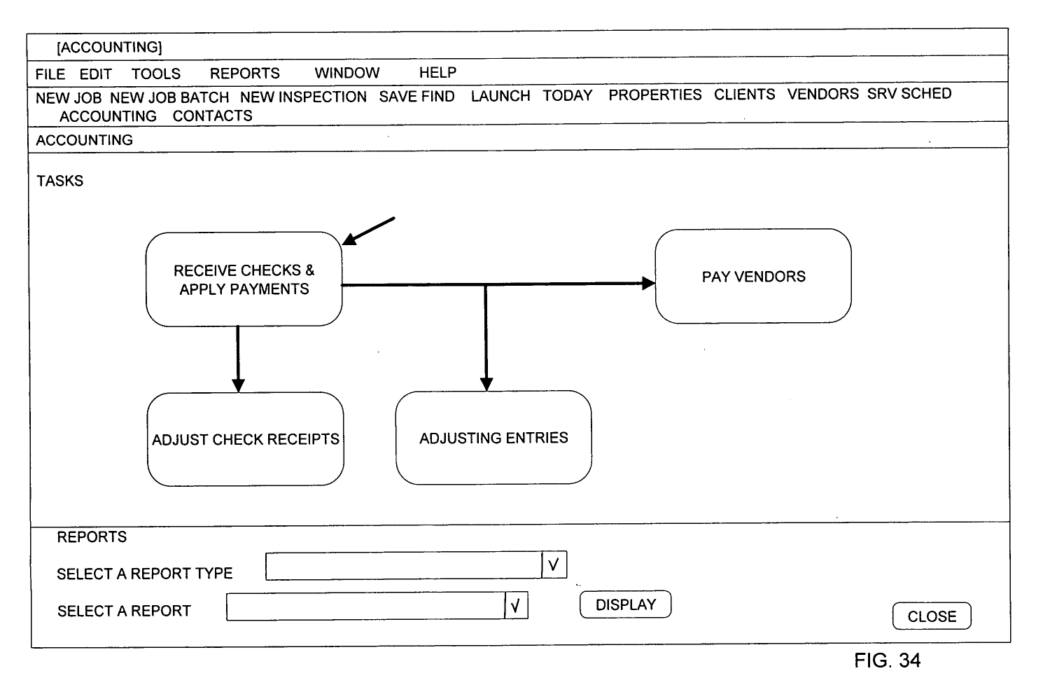

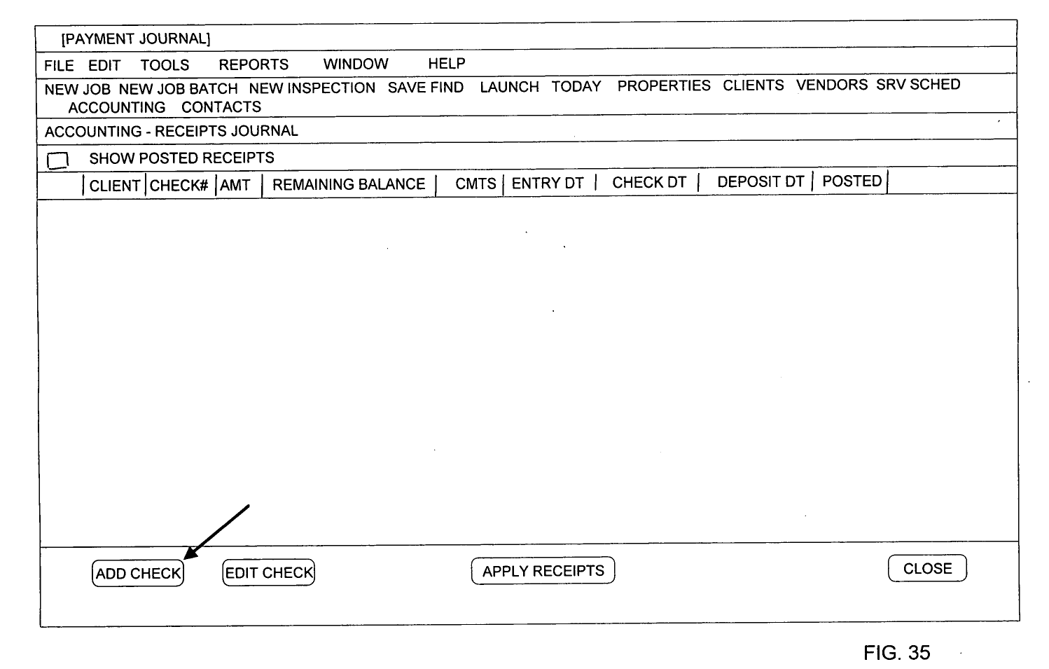

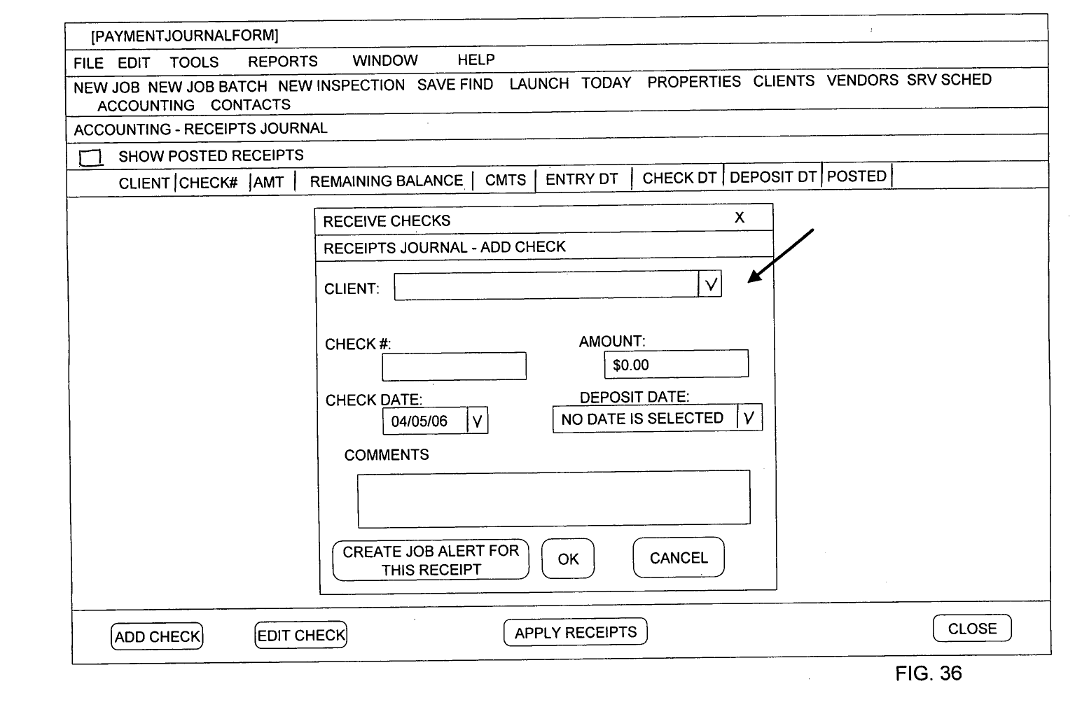

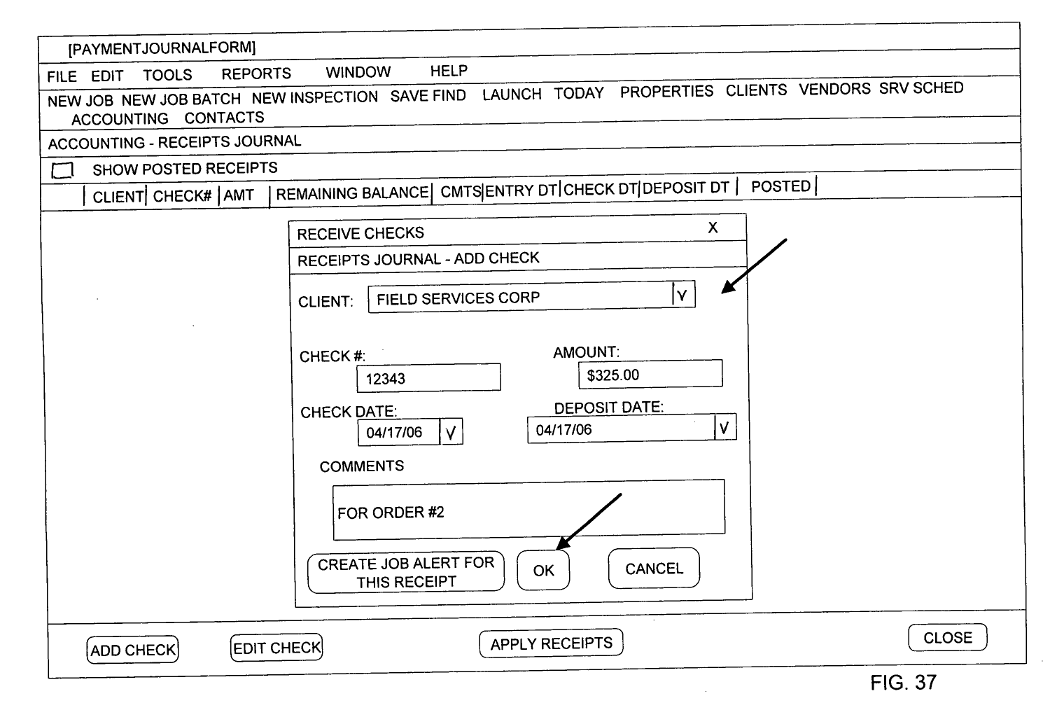

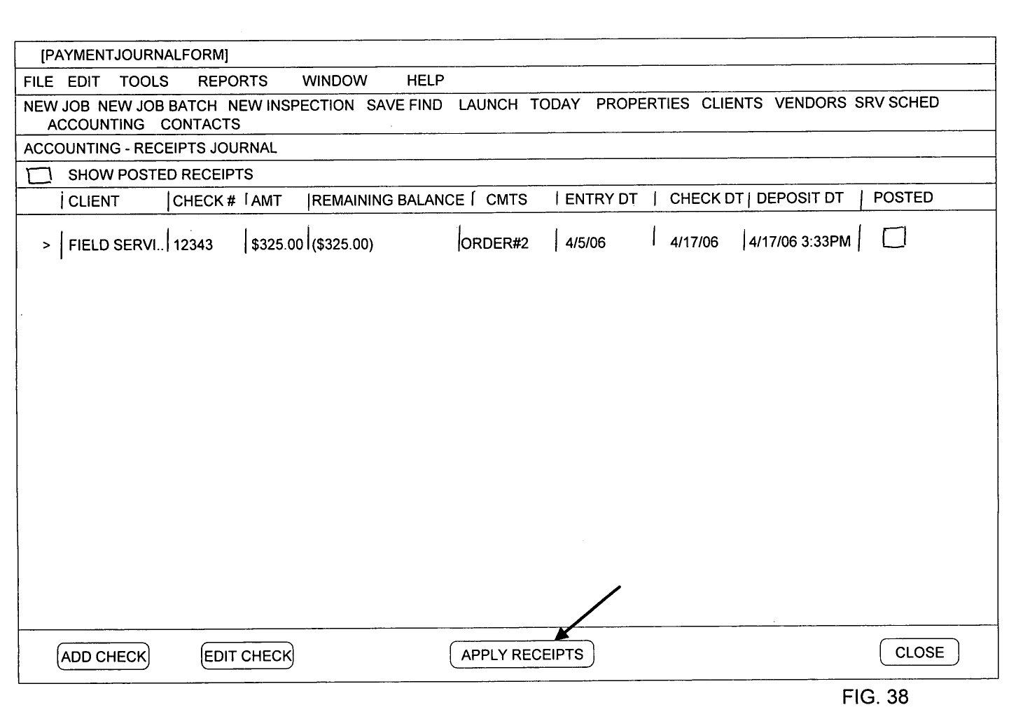

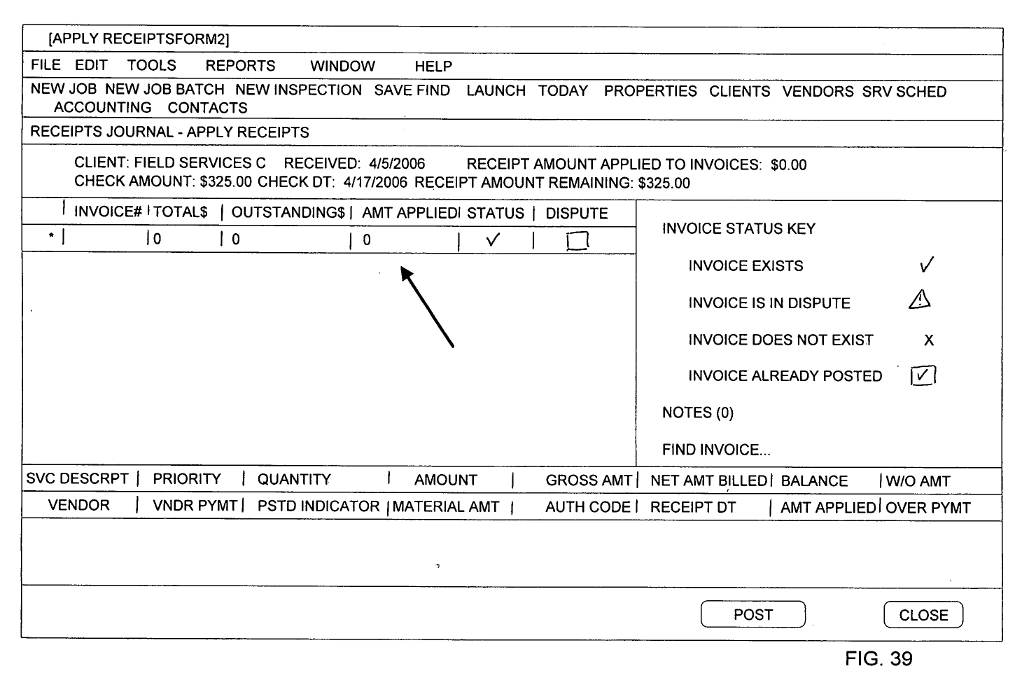

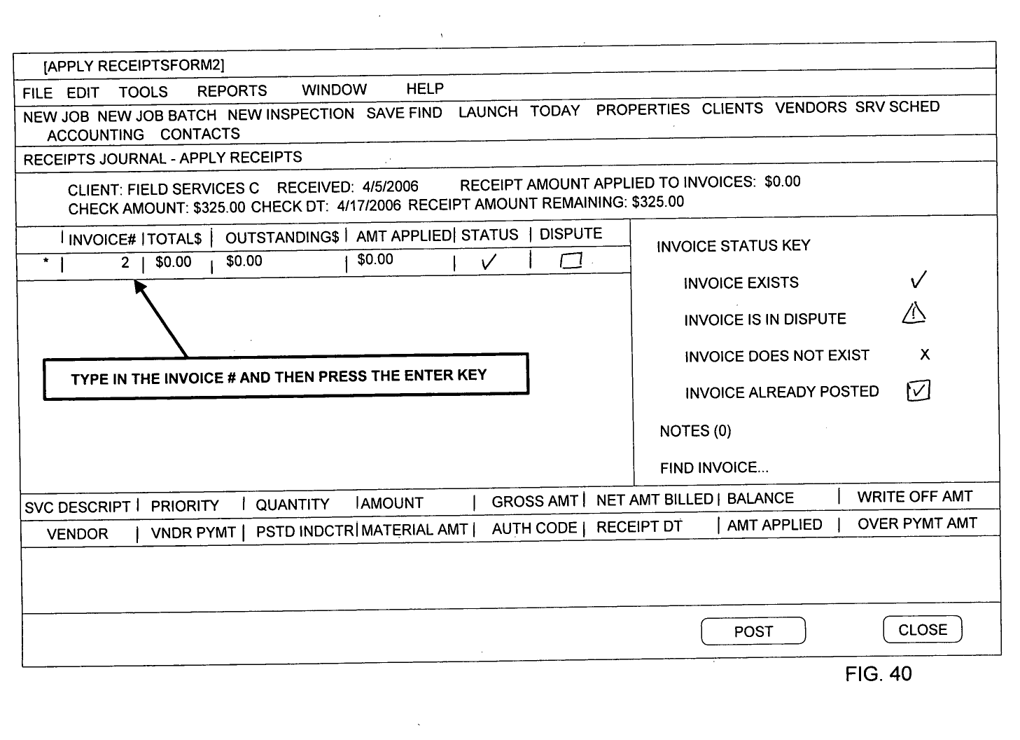

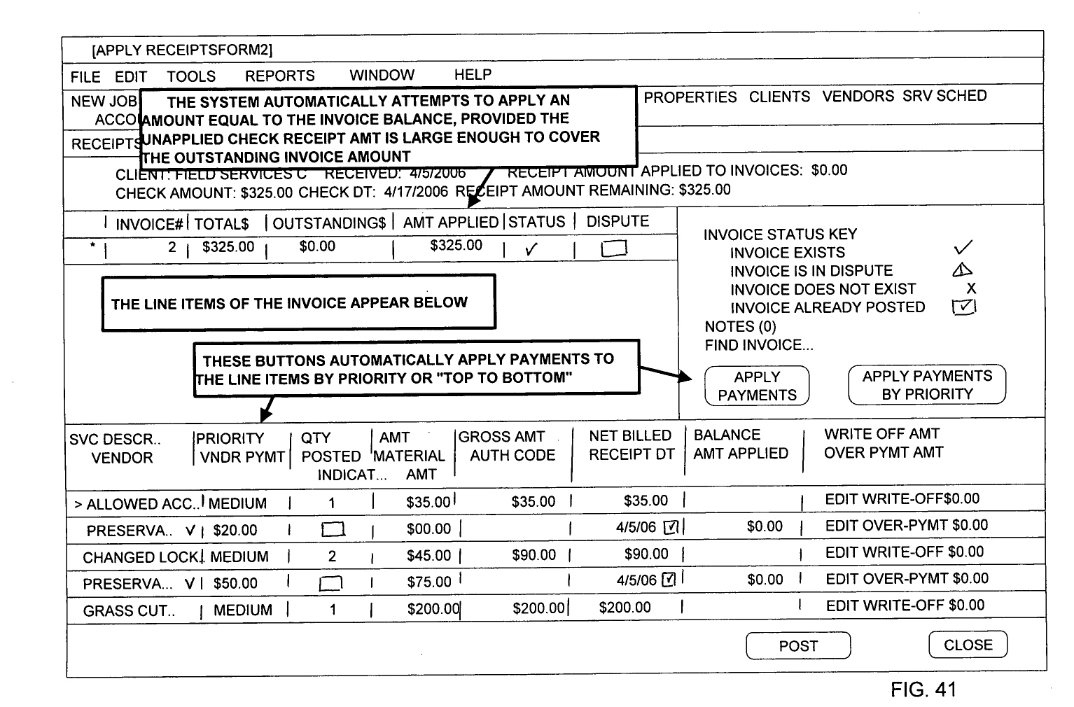

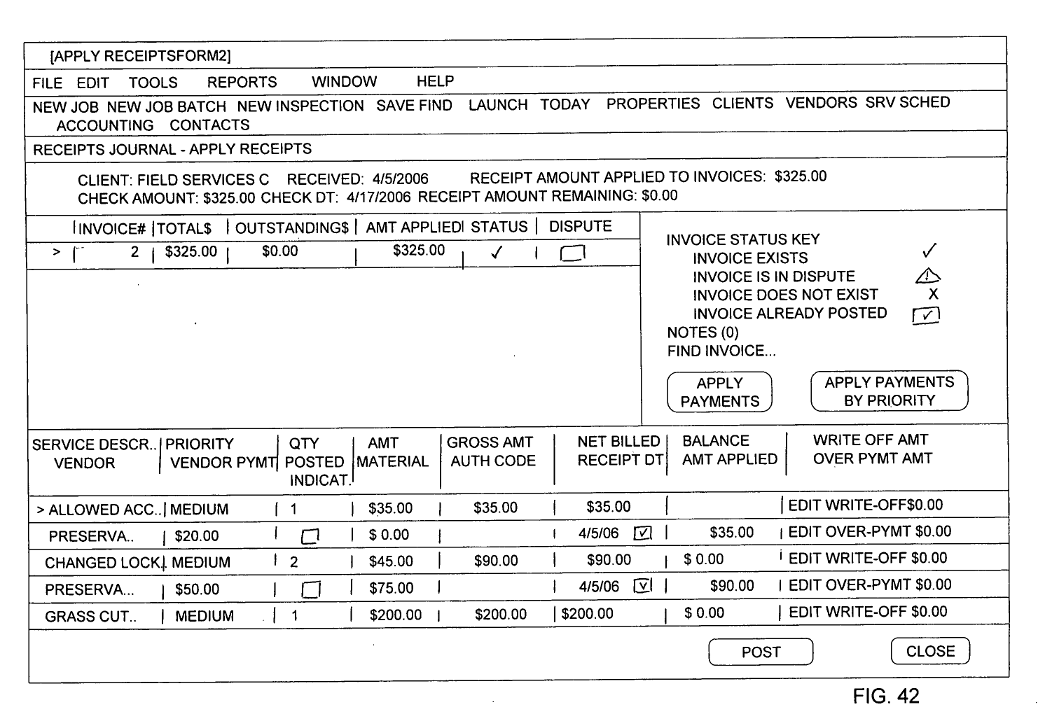

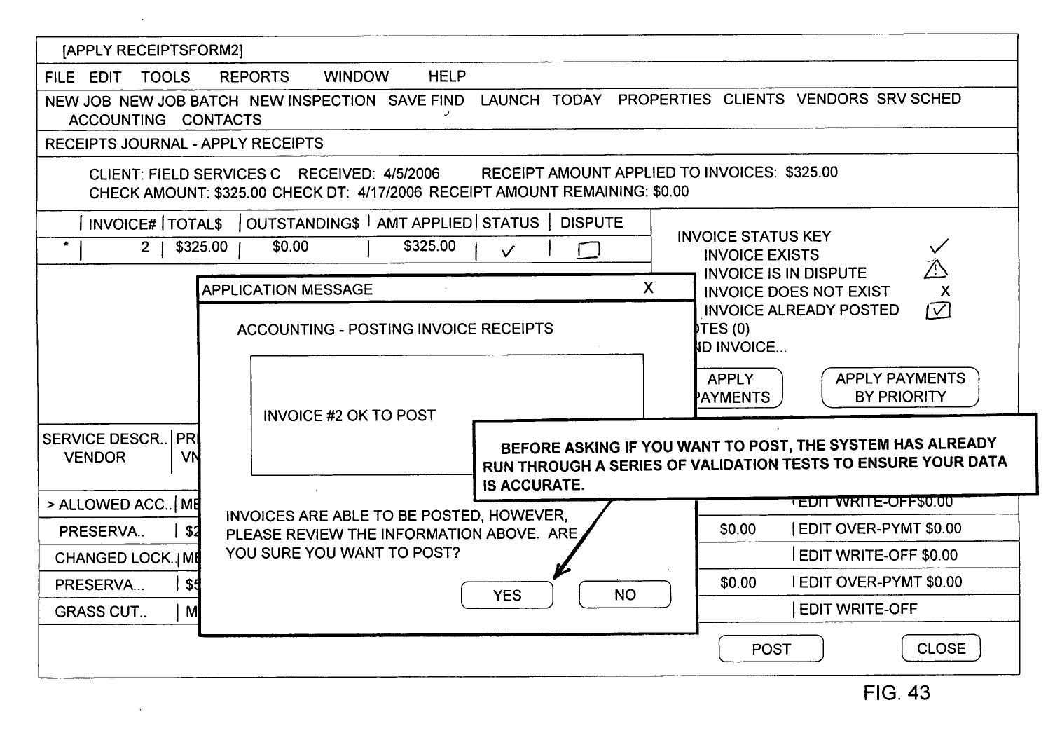

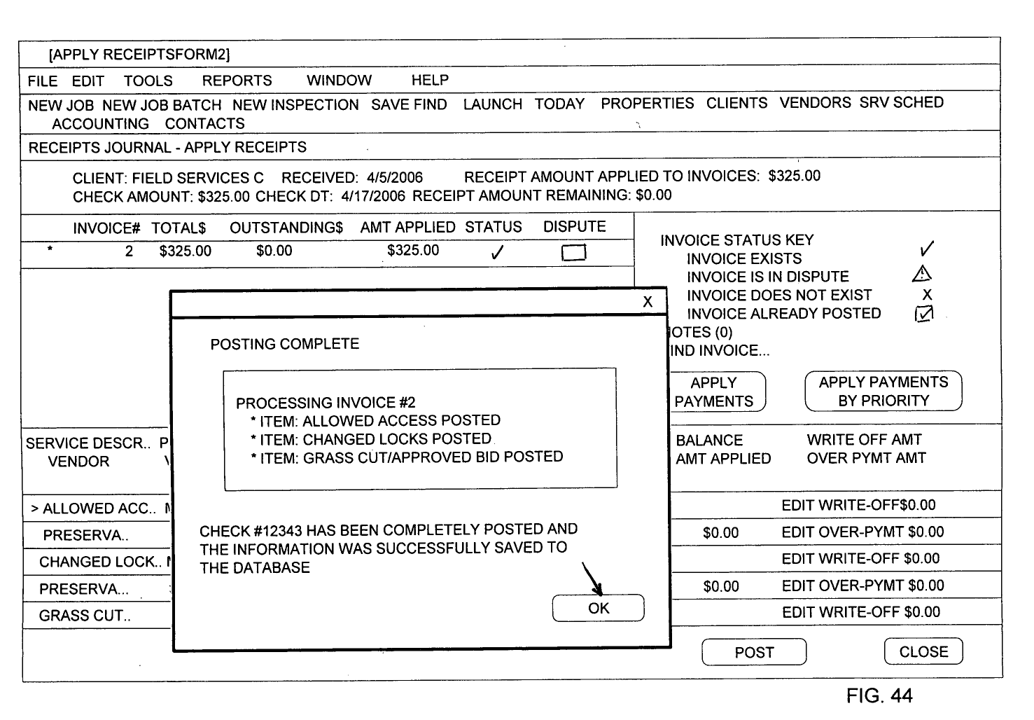

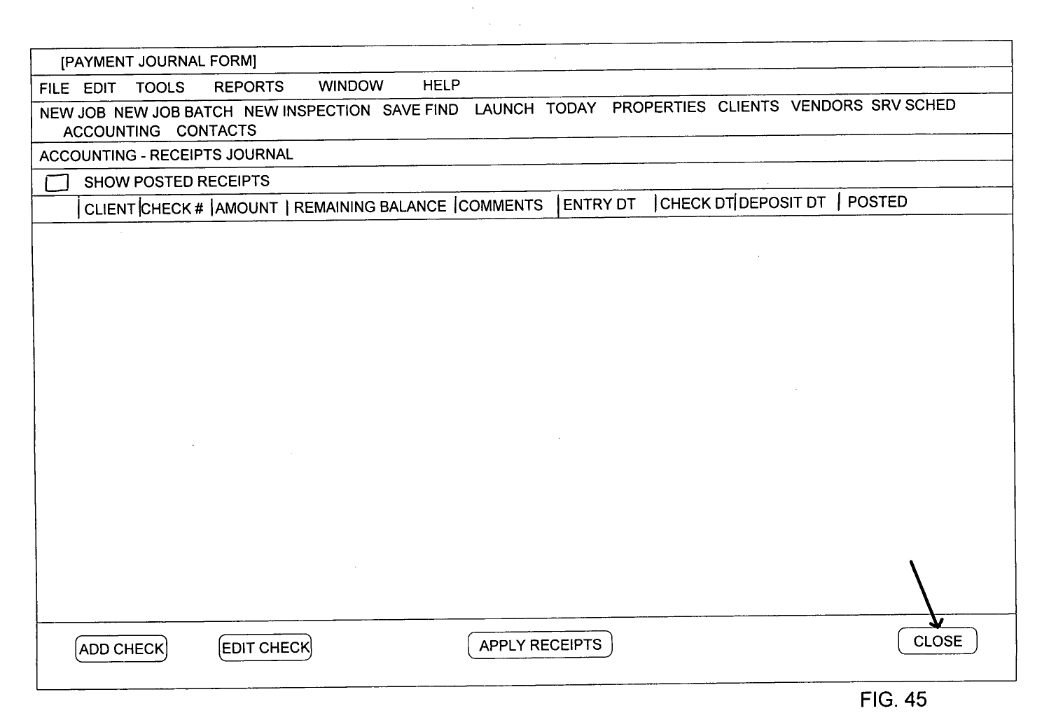

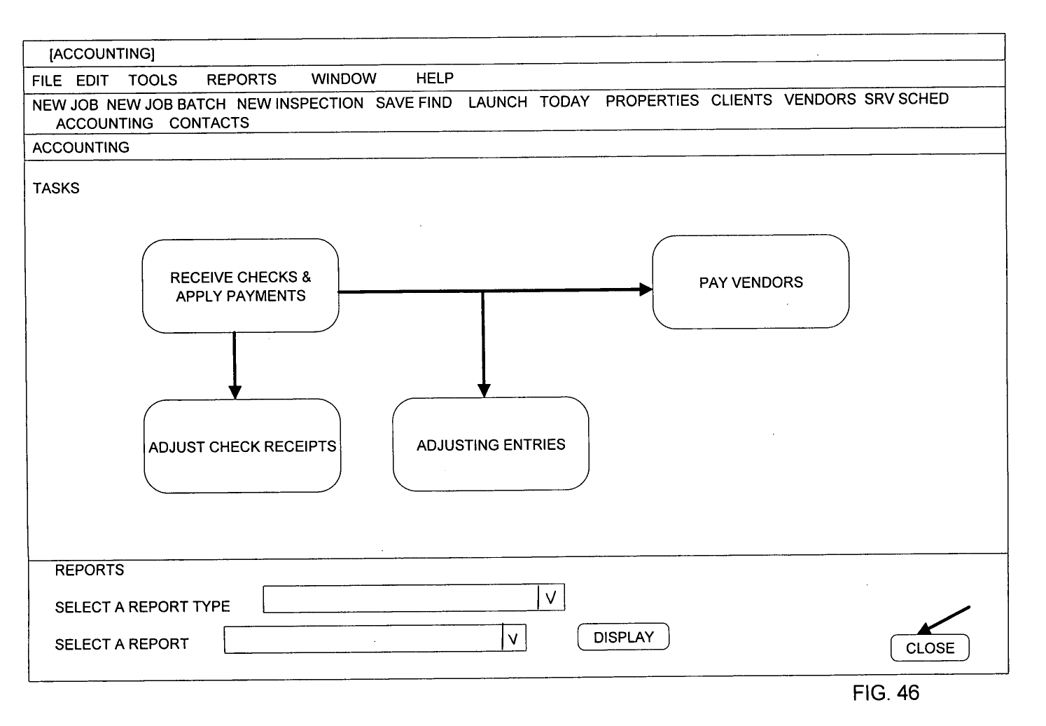

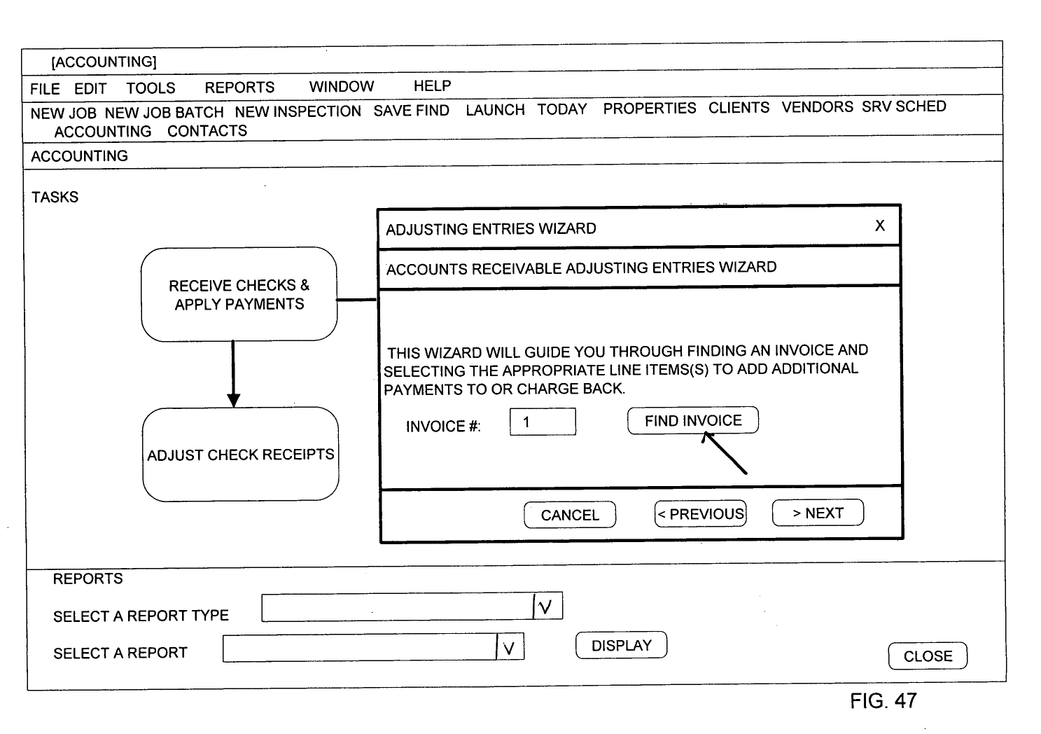

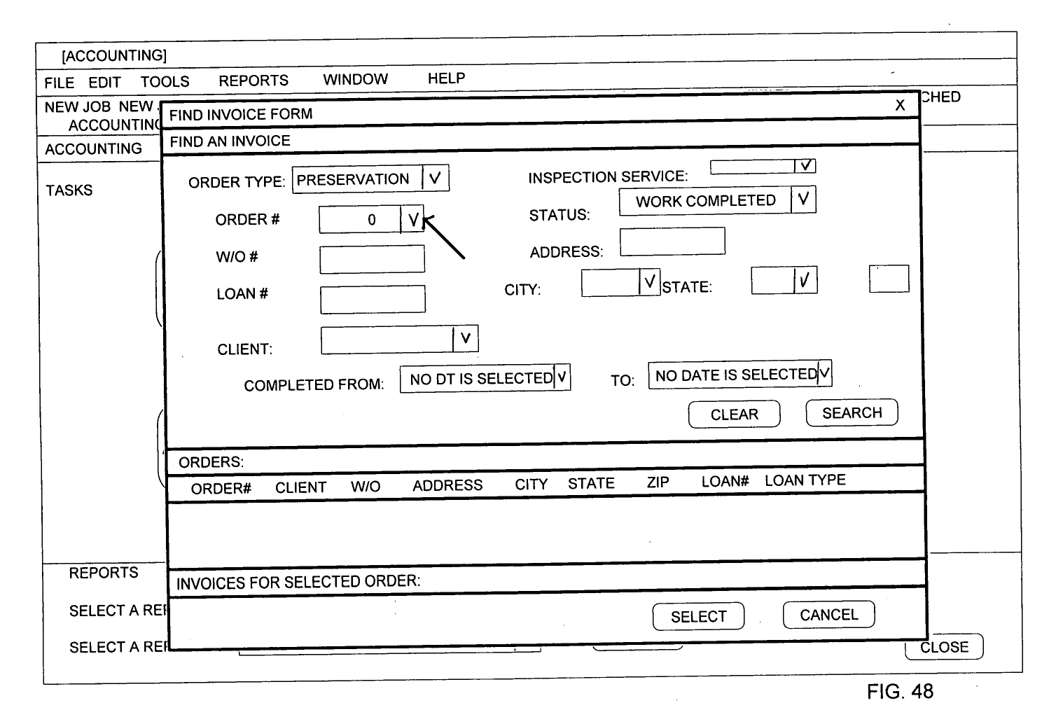

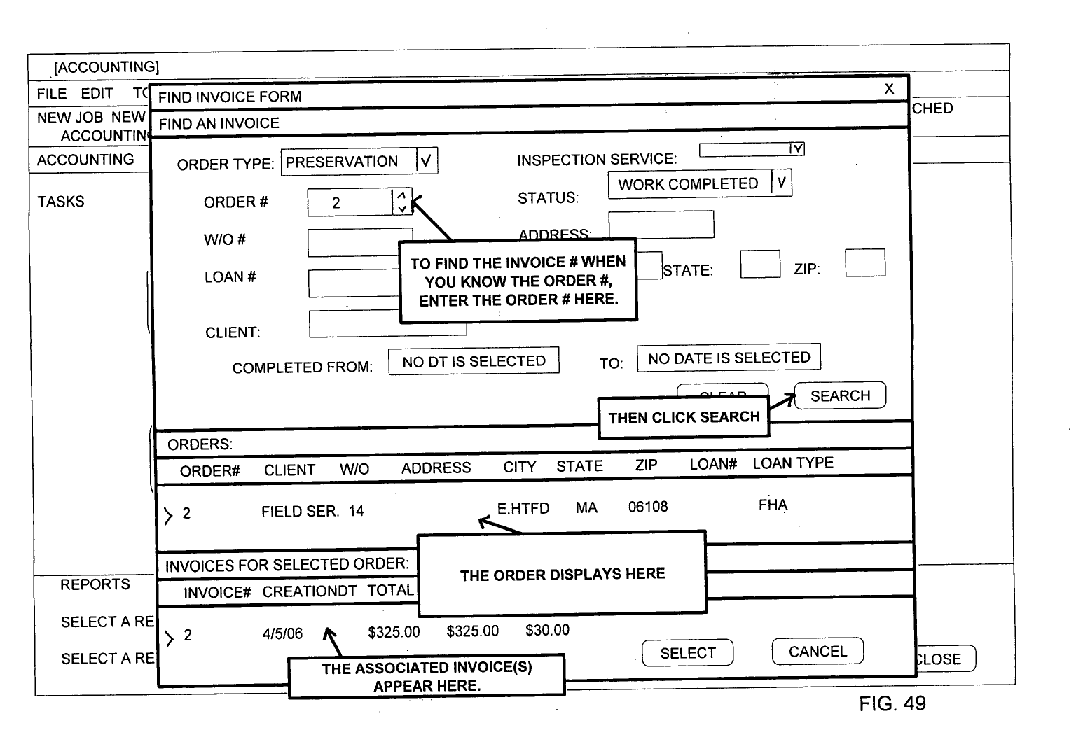

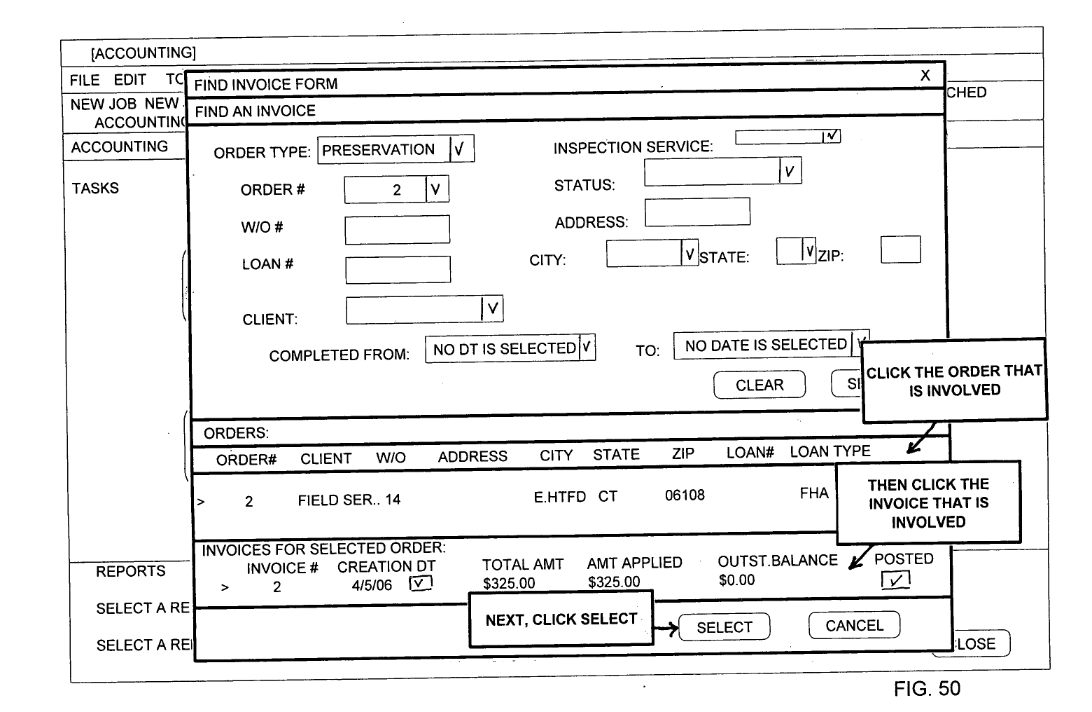

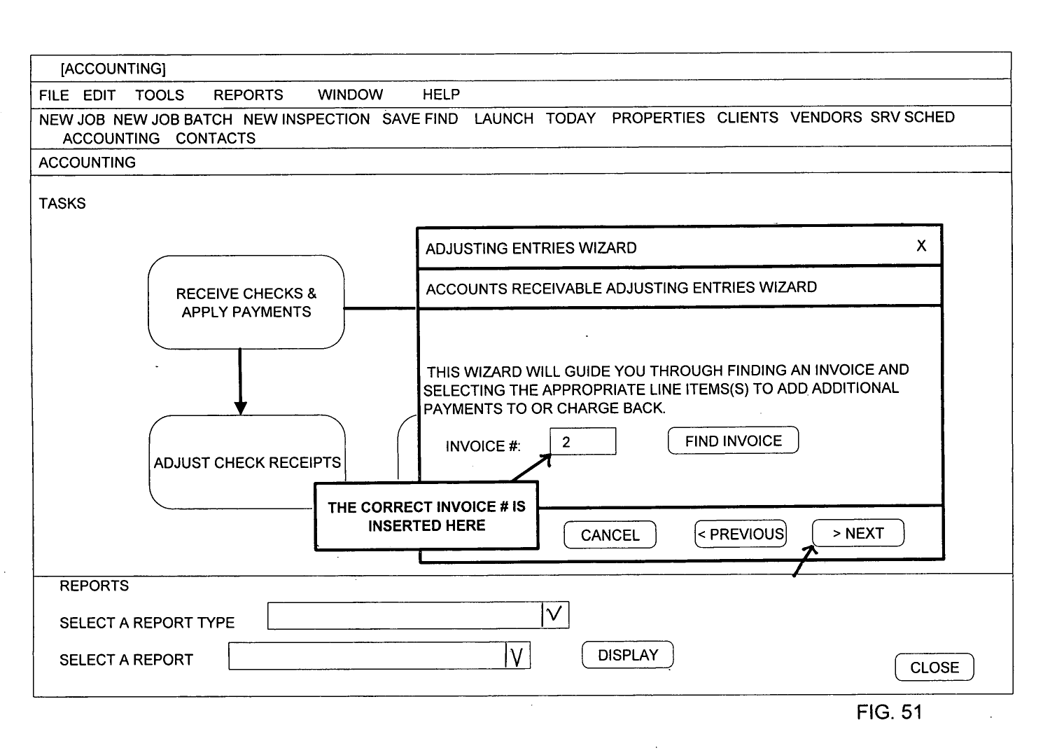

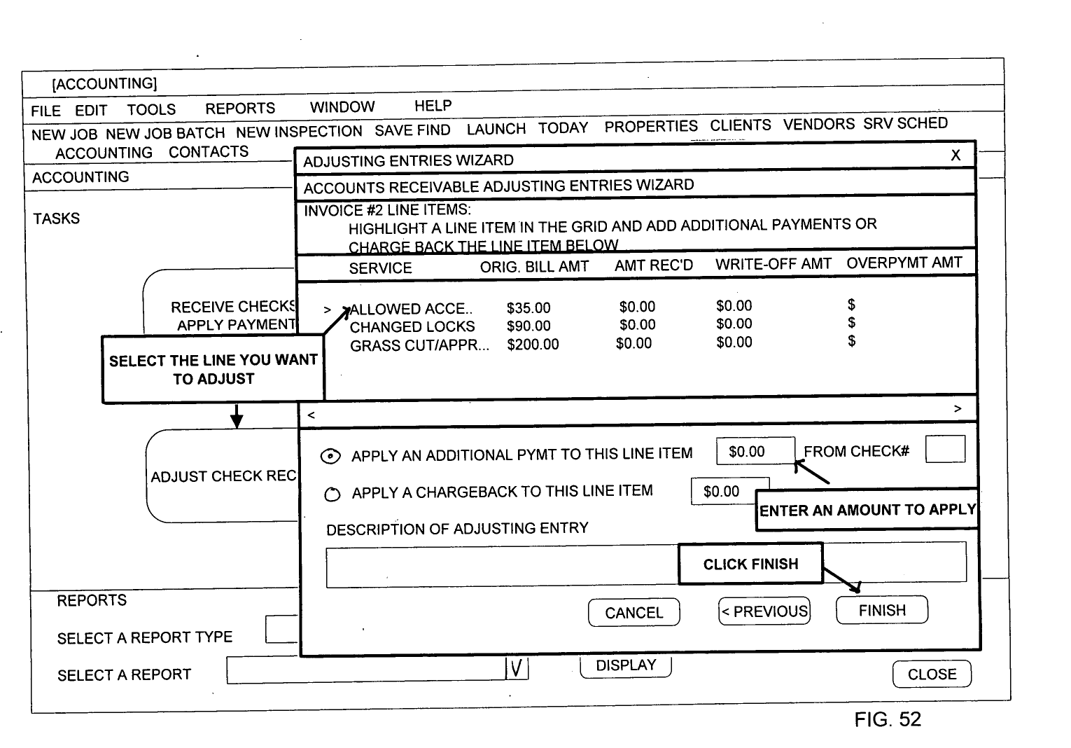

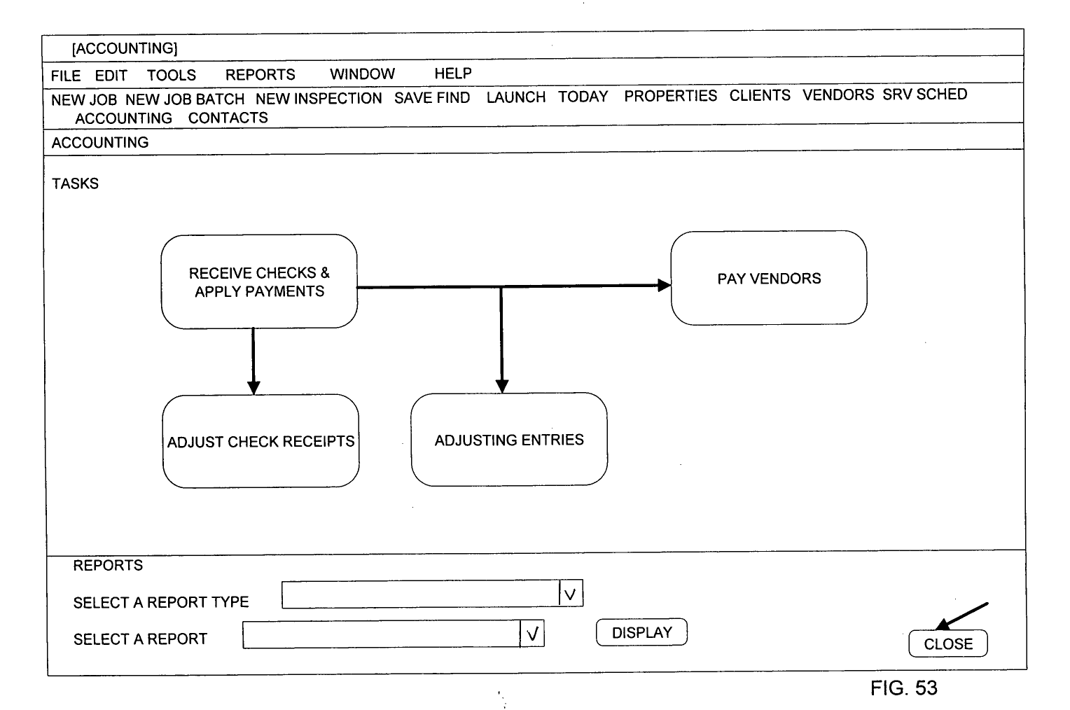

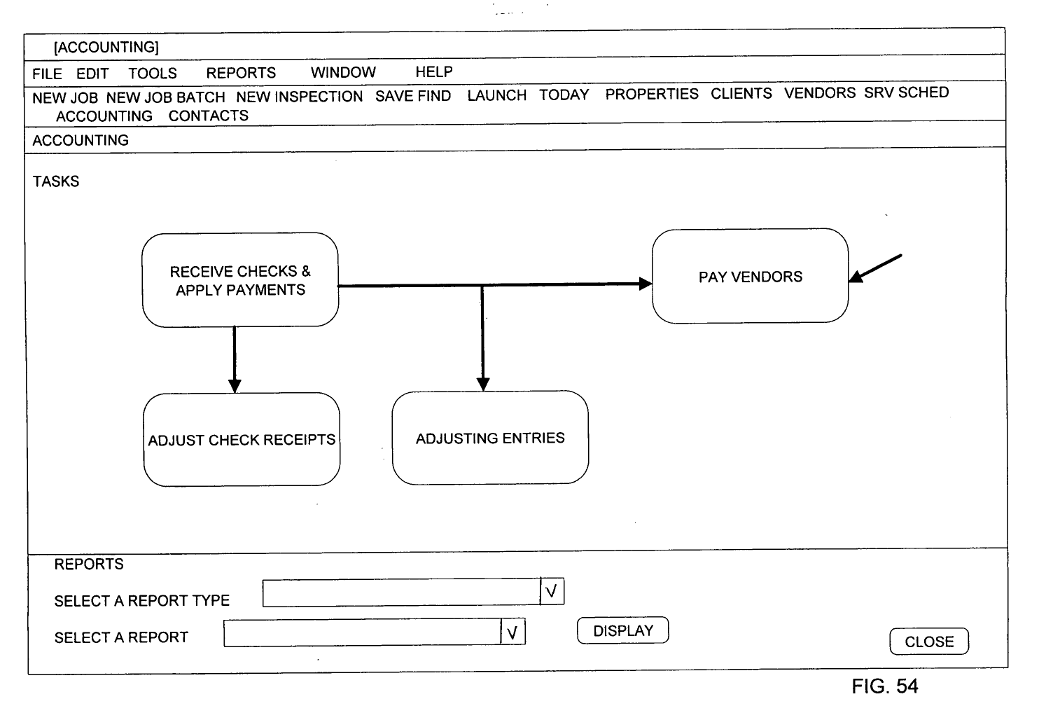

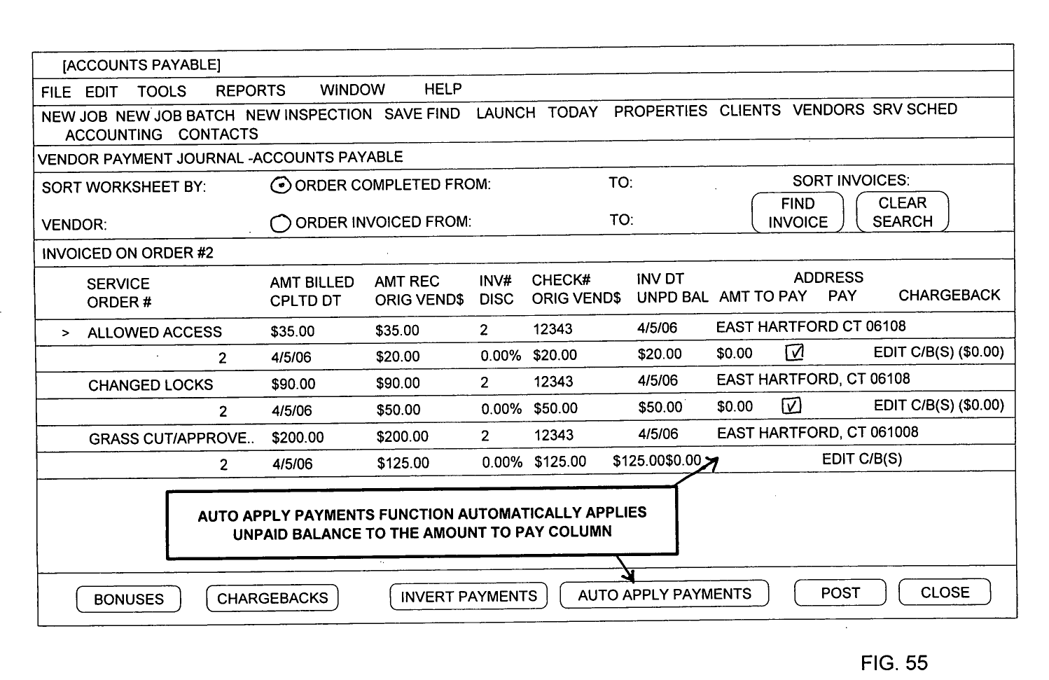

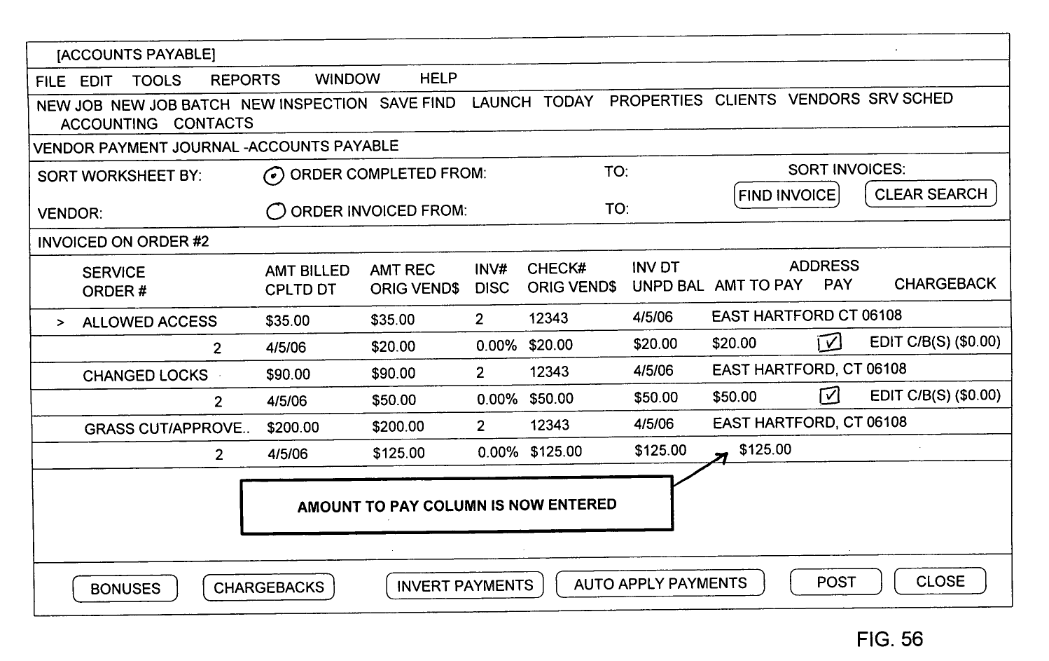

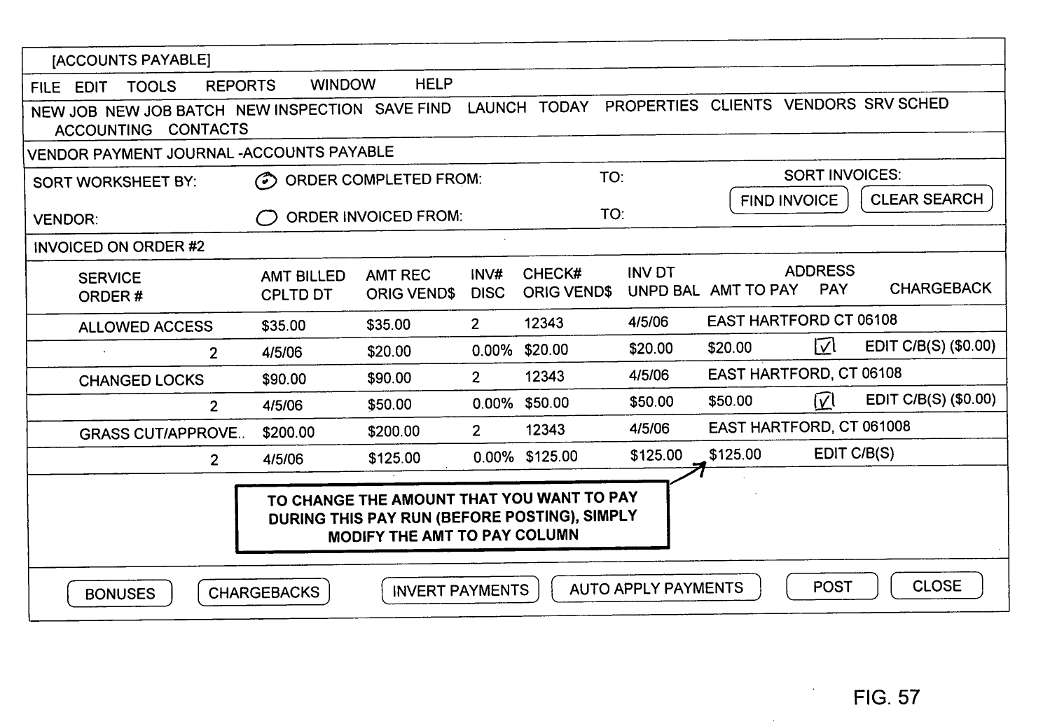

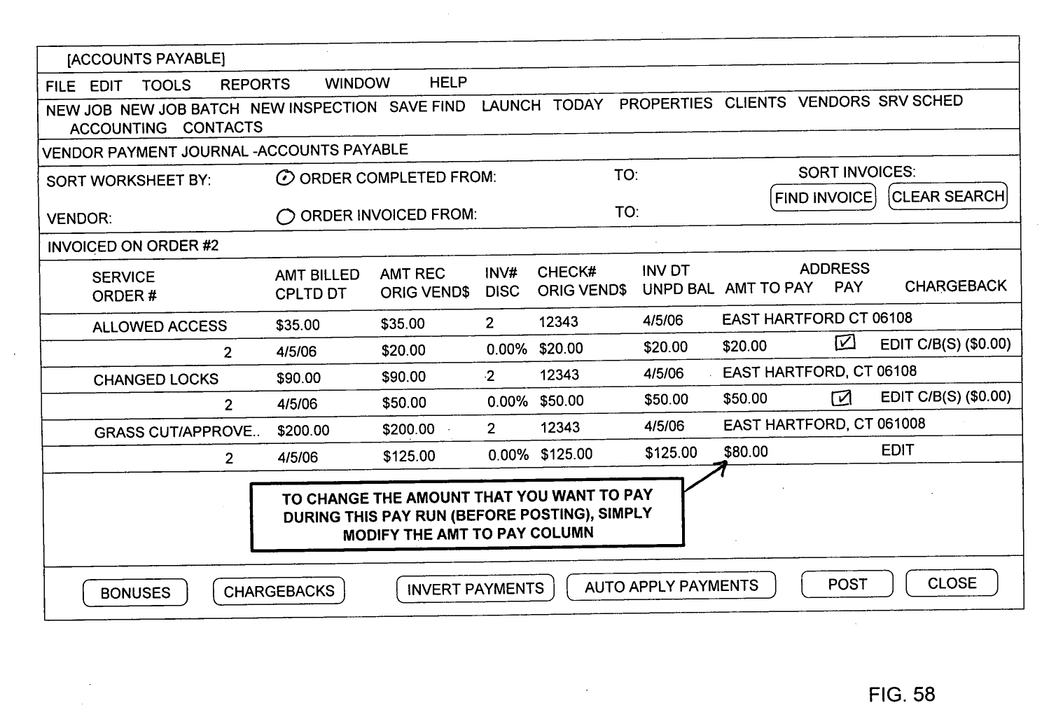

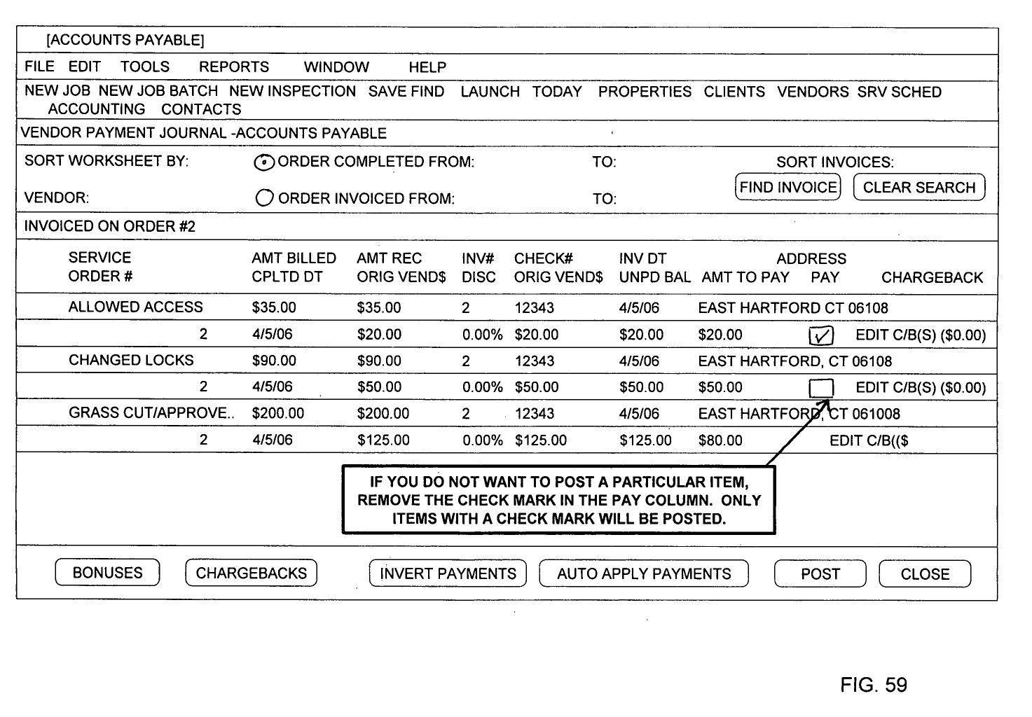

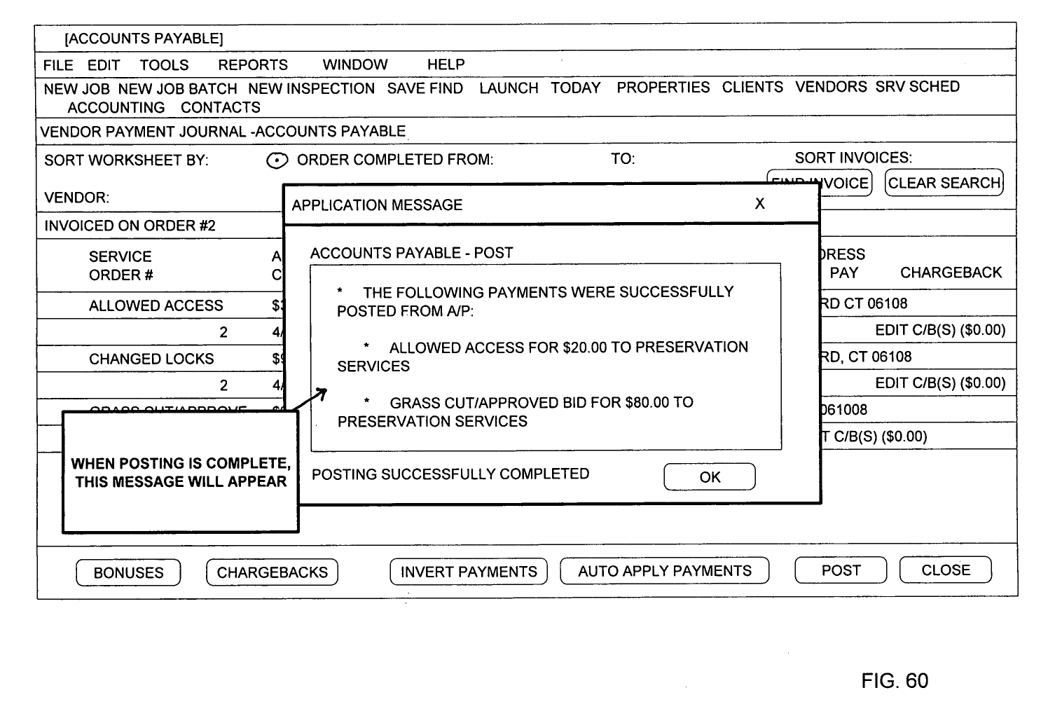

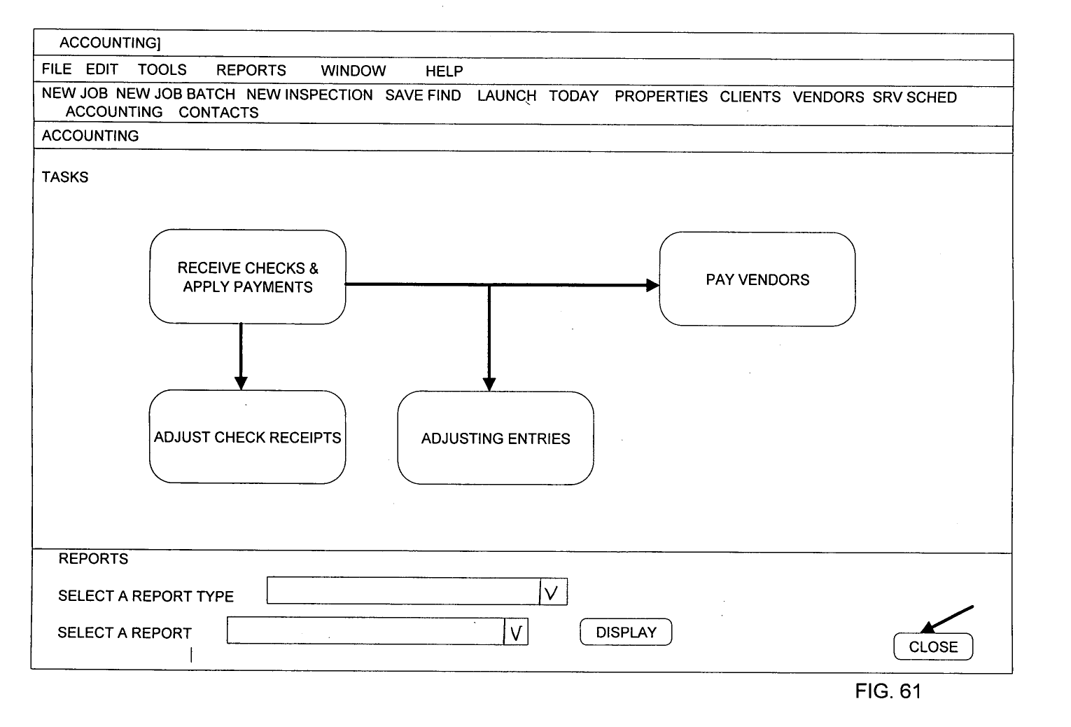

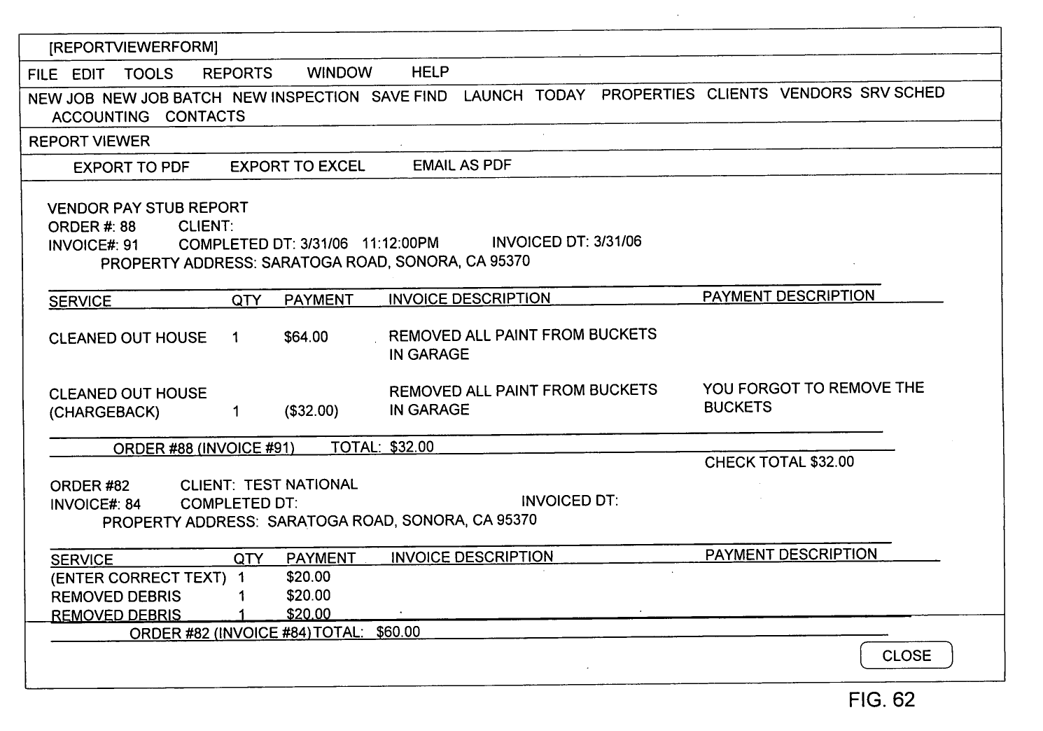

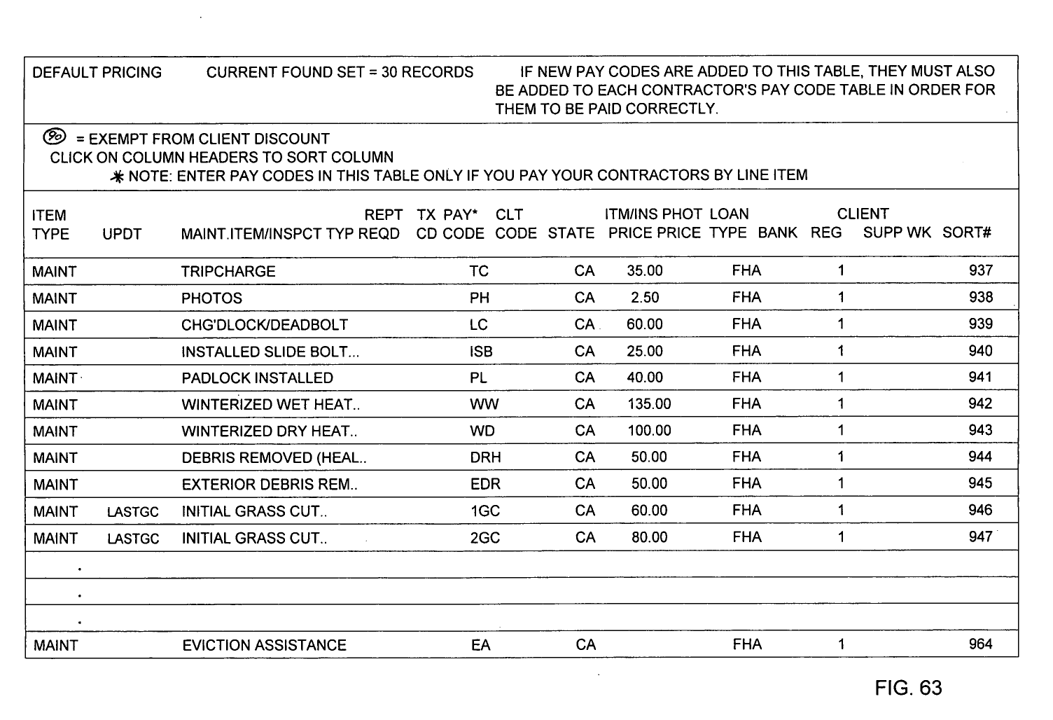

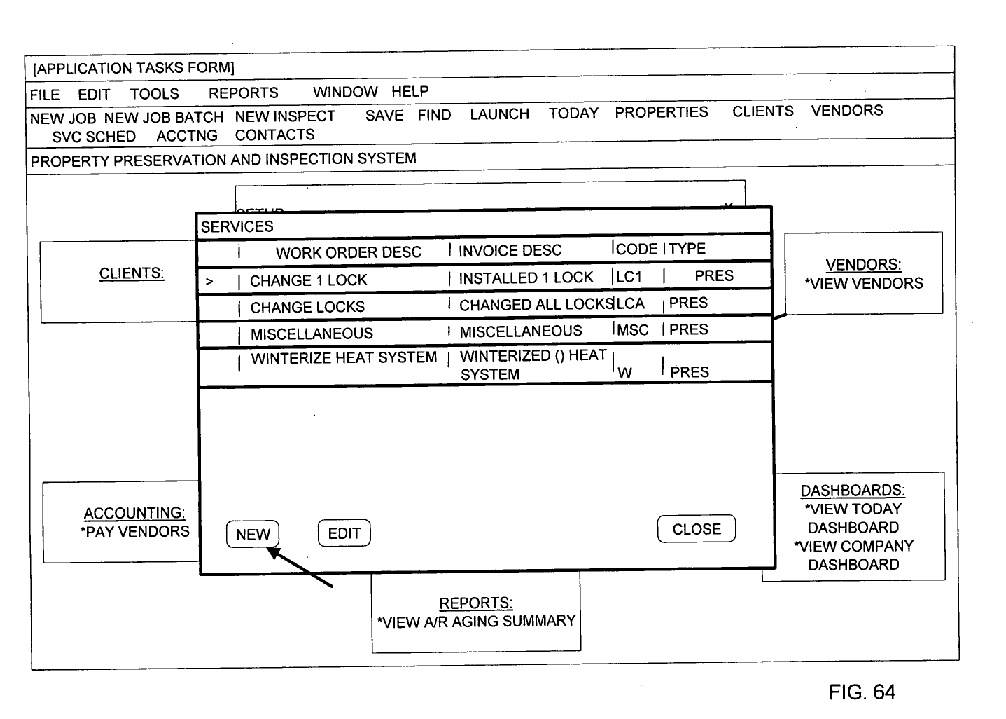

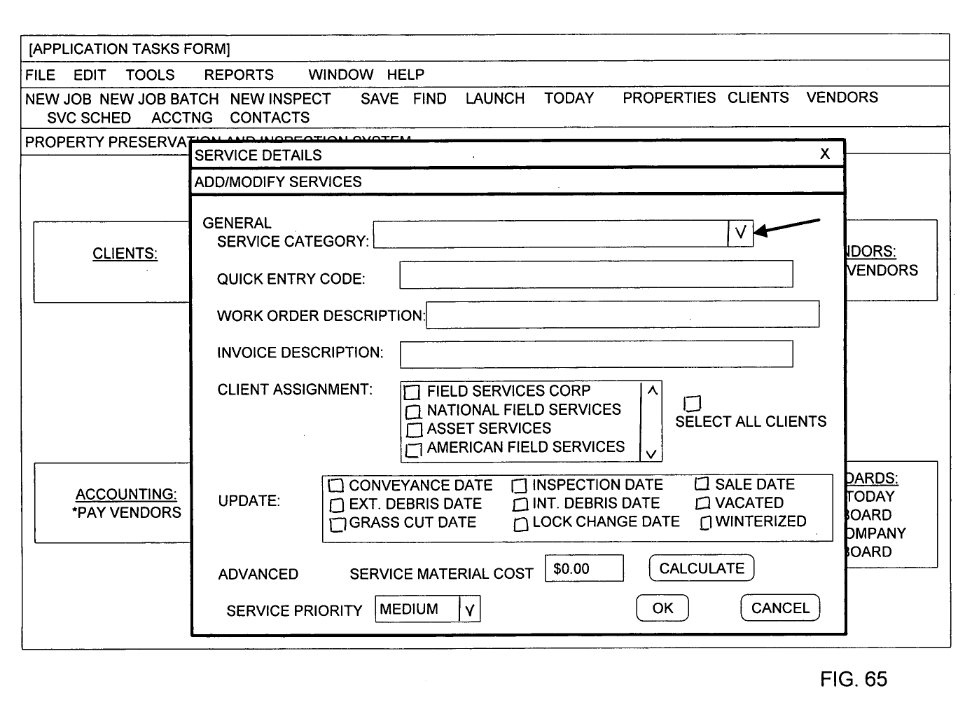

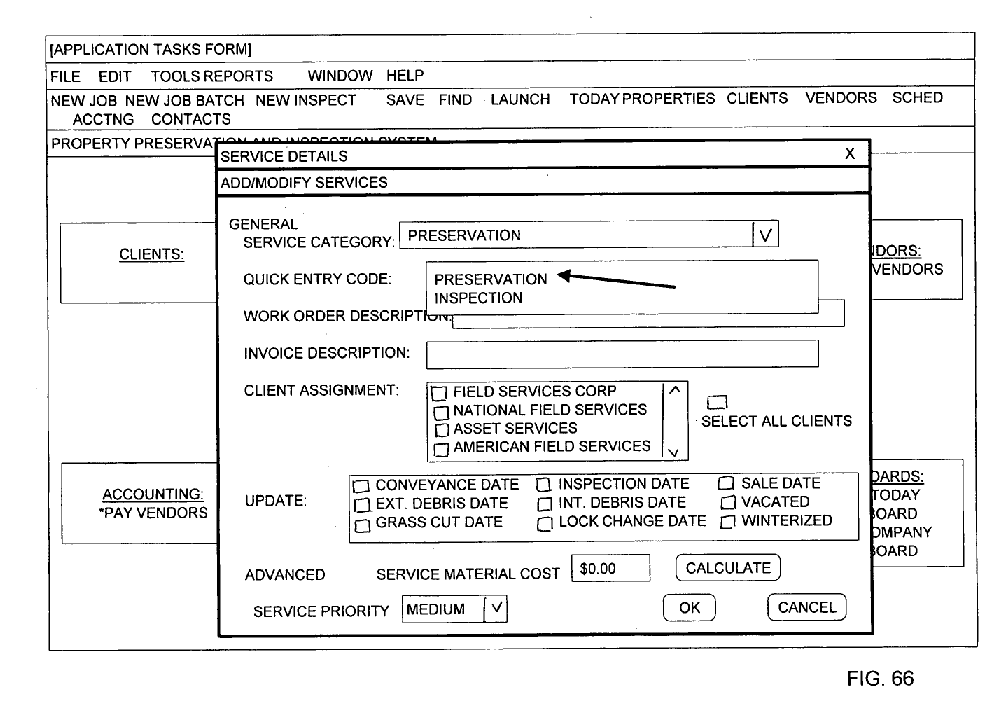

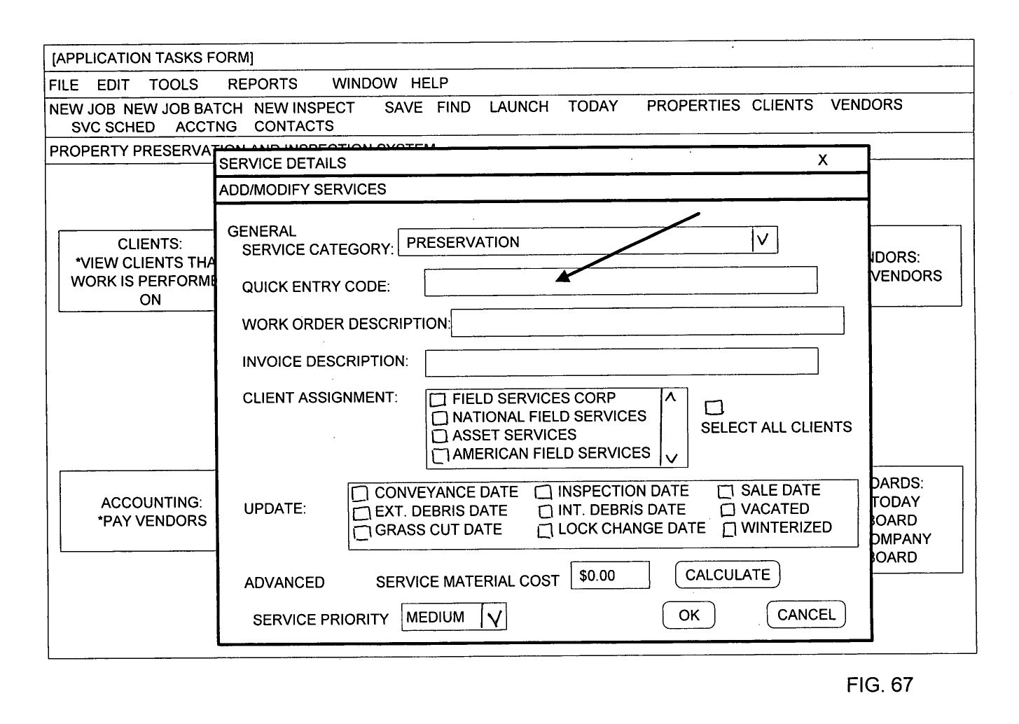

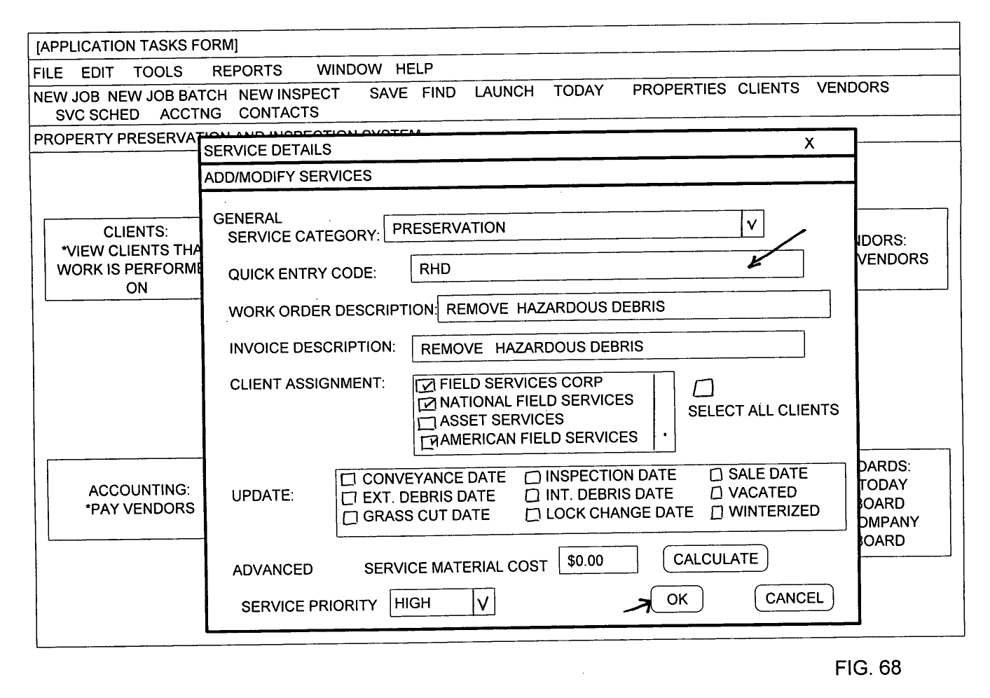

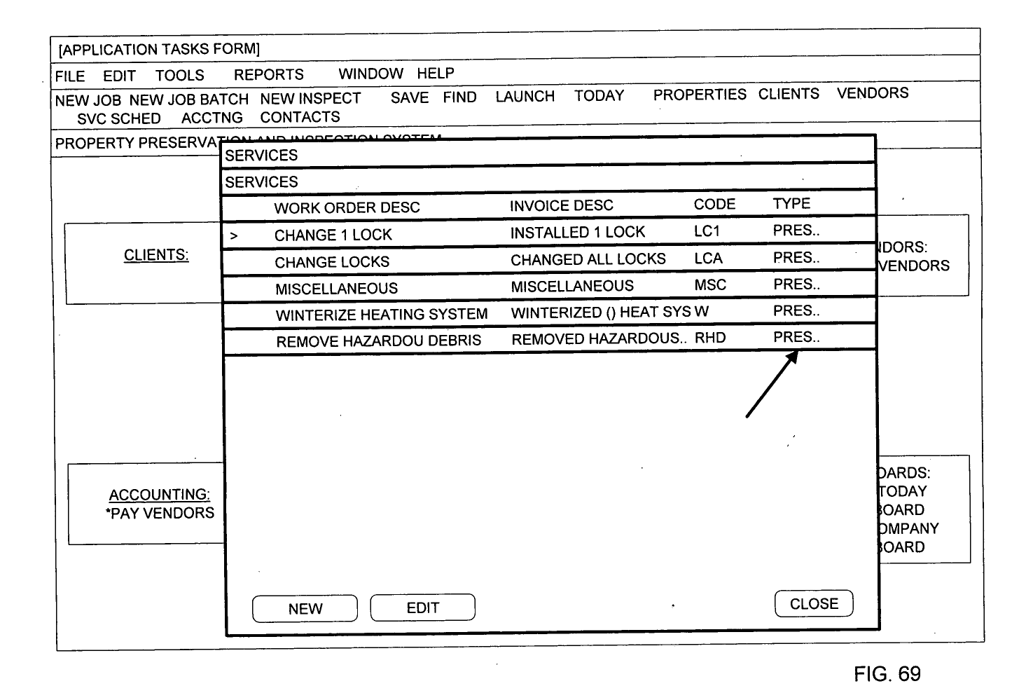

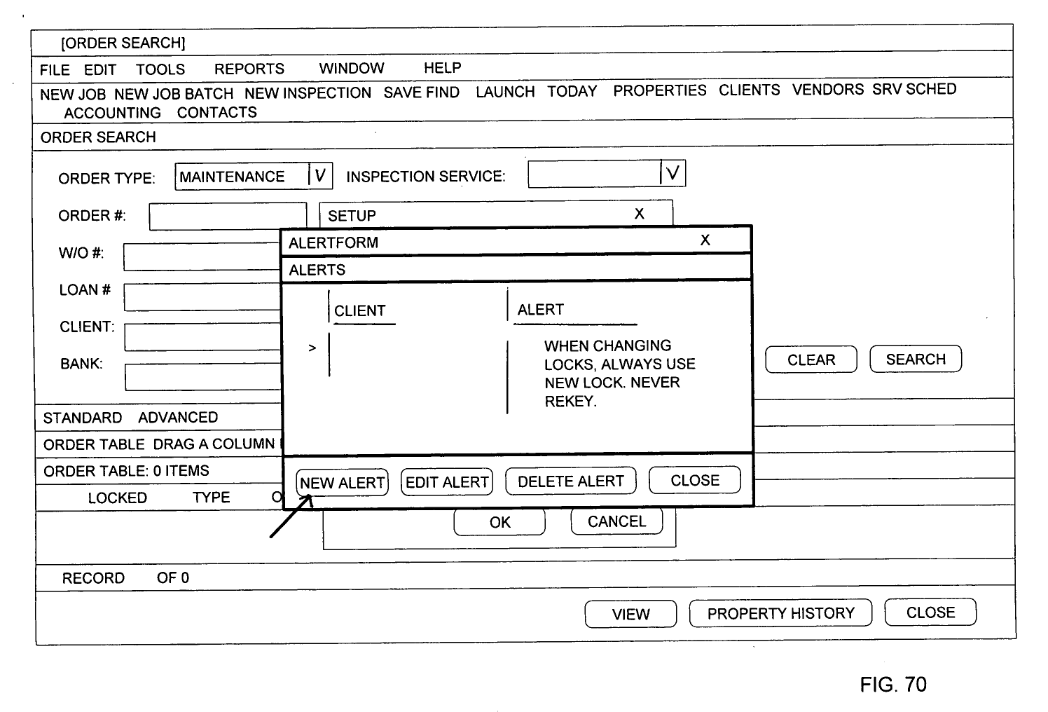

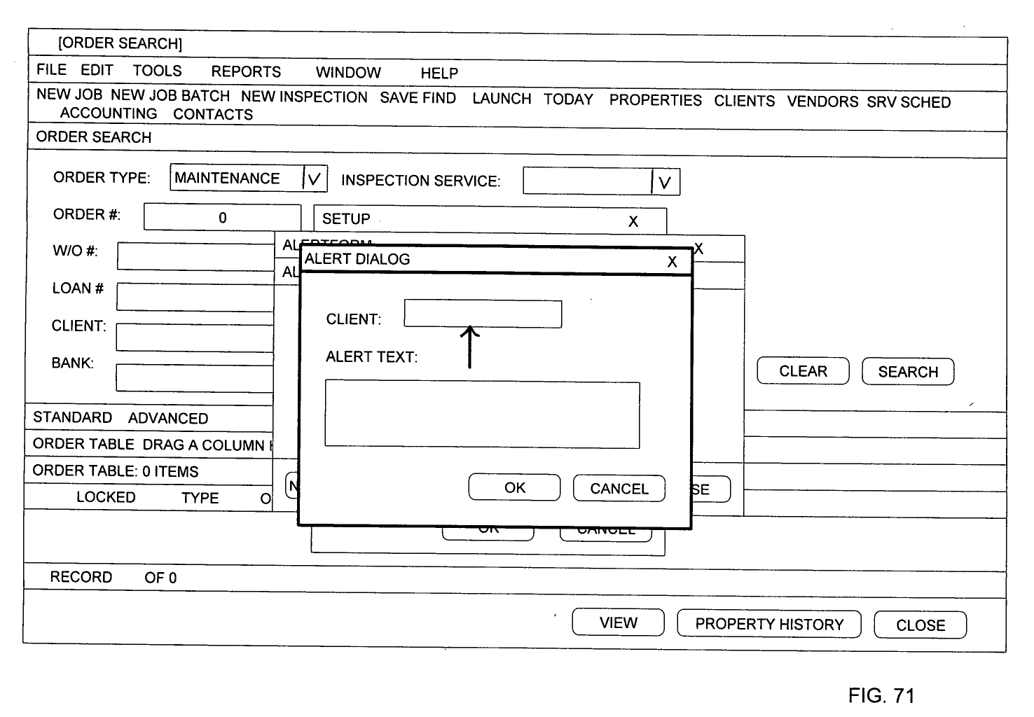

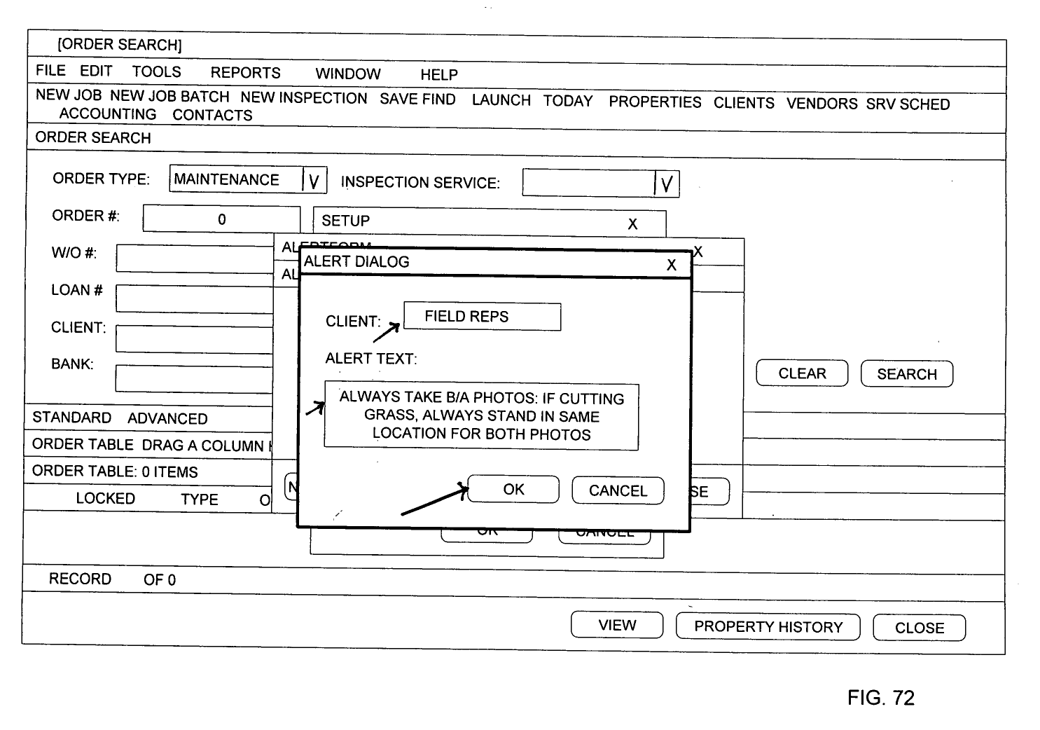

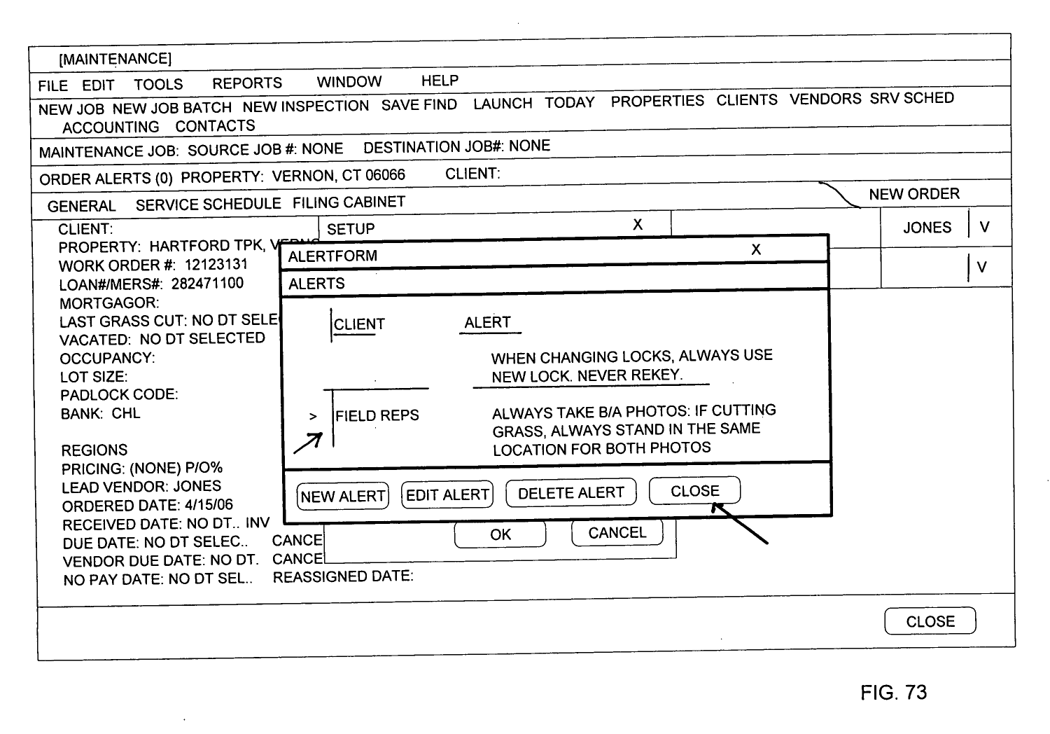

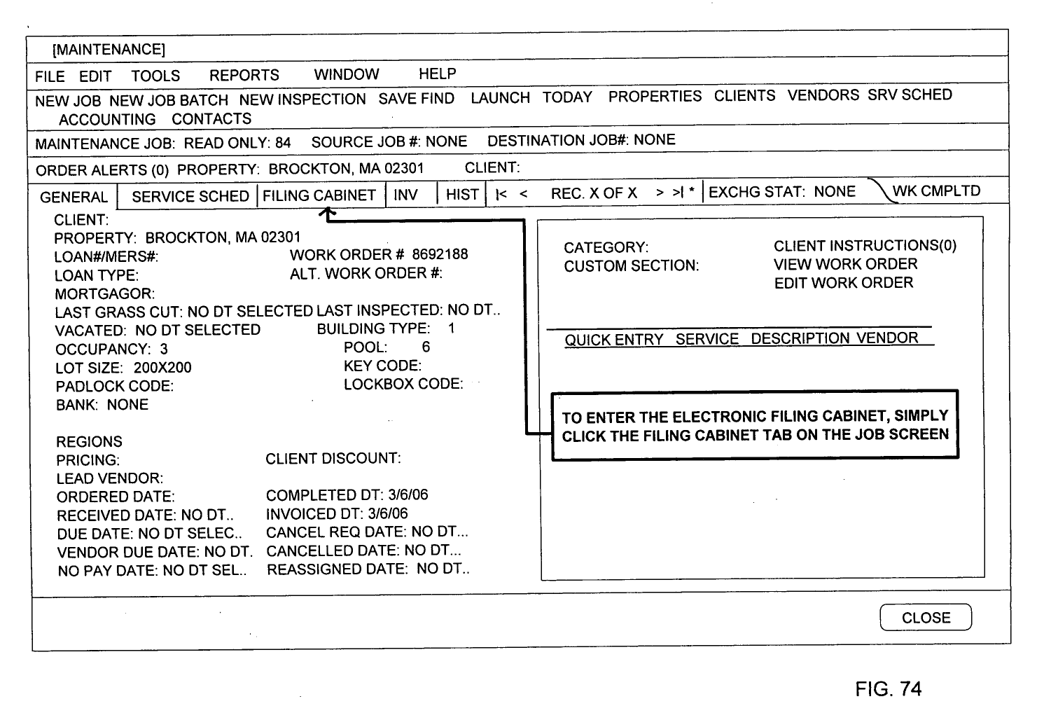

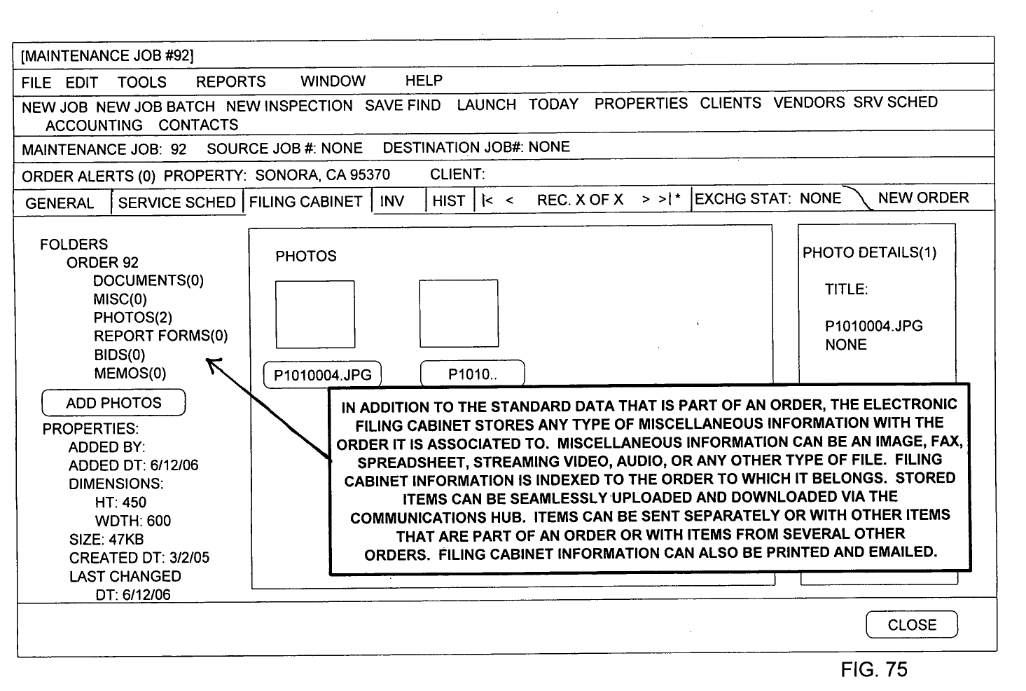

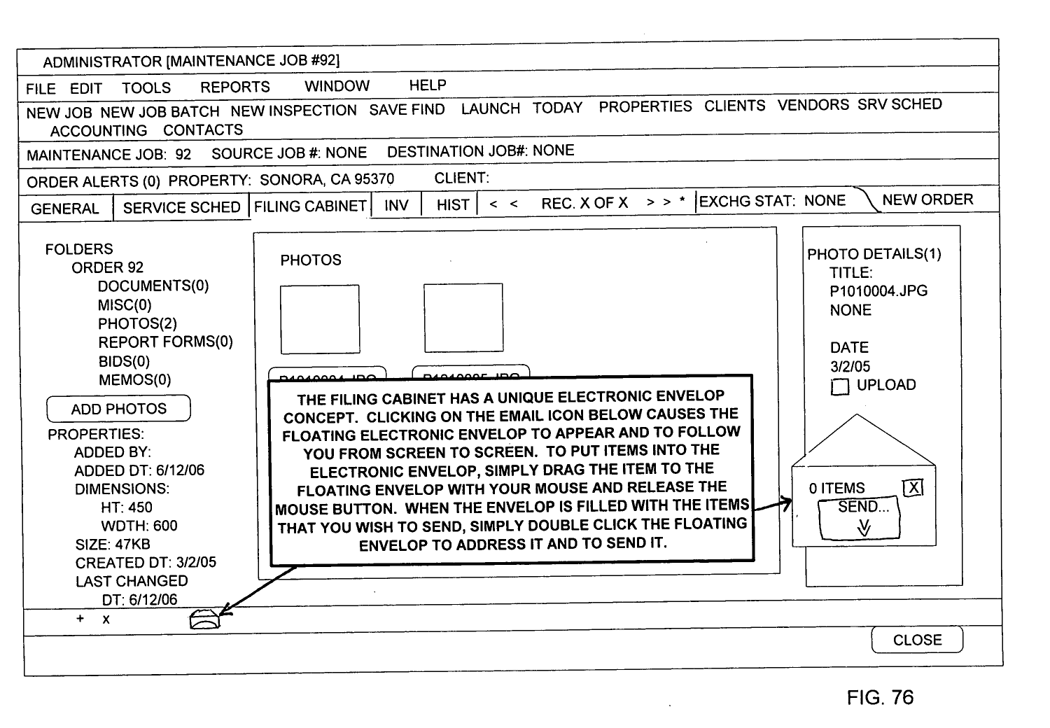

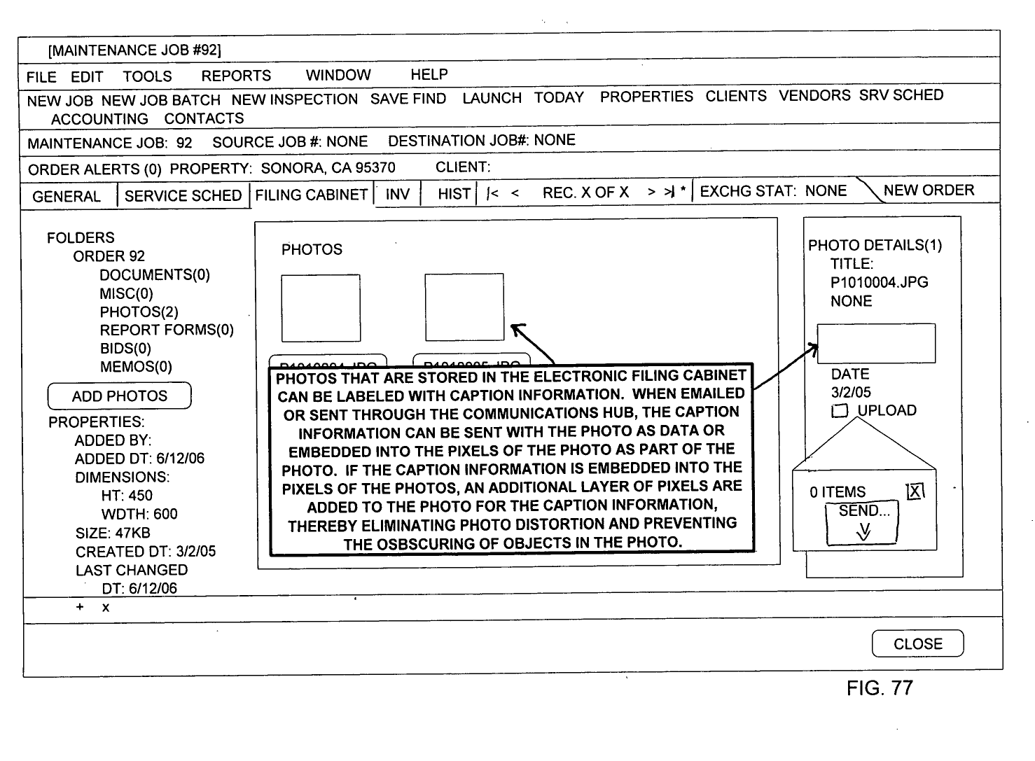

The nature of the services provided by members of the communications hub are defined by the respective members and their functions. For example, a property preservation contractor that services a lending institution may provide services to the lending institution, such as lawn care, changing locks, trash removal, carpentry, winterization, etc. In this example, the lending institution may be classified as a client (as it receives the services of another entity), while the contractor may be classified as a client vendor (i.e., the provider of the services). In another example, a vendor who specializes in a particular service may provide, e.g., home inspection services to the contractor. In this example, the vendor may be classified as a client vendor and the contractor is a client of the vendor. Thus, a single entity may serve as both client and client vendor in some situations. The global exchange services the ability for these entities to be classified into one or more categories (client, client vendor, both). These, and other features and functions will be described further in the flow diagram of FIG. 3 and the related computer screen windows of FIGS. 4 through 77.

Turning now to FIG. 3, a flow diagram describing a process for implementing the global exchange services will now be described in accordance with exemplary embodiments. At step 302, one or more entities to be included in an exchange services hub are identified. As indicated above, these entities may be defined by the services provided and/or the services provided to the entities.

At step 304, the exchange service entities identified in step 302 are classified according to client and client vendor. As provided above, an entity may be classified in some situations as both client and client vendor. FIGS. 4-9 illustrate sample computer screen windows for viewing, adding, and modifying subscriber clients. FIGS. 10-12 illustrate sample computer screen windows for viewing, adding, and modifying non-subscriber clients. FIGS. 13-14 illustrate sample computer screen windows for viewing, adding, and modifying non-subscriber client vendors. FIGS. 15-18 illustrate sample computer screen windows for viewing, adding, and modifying subscriber client vendors. Computer screen windows in FIGS. 19-21 provide a means for adding, viewing, removing particular clients, namely lenders.

At step 306, a subscription status identifier is determined for the client and the client vendor(s). The subscription status identifier specifies whether a client/client vendor is a subscriber of the global exchange services. A non-subscribing entity, e.g., may be a service provider that is utilized by contractor though the service provider is not a registered global exchange member. Non-subscribing entities do not have access to the global exchange applications or associated services.

At step 308, the client and vendor(s) are grouped according to geography. This grouping feature provides several advantages. For example, a provider of inspection services may be specified as available for inspection services for properties within a specific geographic location (e.g., local, regional, national). A national service provider may be registered, e.g., as a client vendor for multiple locations around the country while a small business that services a local area may be designated as providing services to this limited local area. In addition, clients and/or client vendors may be defined as exclusive service providers for a particular client, geography, or service. In addition, a particular geography may be defined for a client, client vendor, and/or service. Grouping may be established by other schemas as well. For example, two schemas—pricing and discount may be selected and associated with a geographical region for establishing common charges for various services. These, and other, grouping features are available via the global exchange services. These grouping features are shown in part in the computer screen windows of FIGS. 26-33.

At step 310, hub feature access and capability privileges are specified for each of the exchange service entities. A high-level administrator may assign specific capabilities and access permissions to other entities within the hub. These assignments may limit the ability of designated entities within a hub to view or modify settings, data, and other resources of the communications hub to which they belong. Computer screen windows shown in FIGS. 22-25 illustrate these features in further detail.

At step 312, accounting preferences, service fees, and service definitions and instructions for services provided by the exchange service entities are determined. Accounting preferences may include, e.g., a manner of receiving checks and applying payments (adjusting check receipts, adjusting entries, and paying vendors), adding a check and adjusting various line entries. These and other accounting features are shown in the computer screen windows of FIGS. 34-62. Service fee features enable an entity to set up pricing by creating a pricing table that includes defined services and vendor pay codes (see, e.g., computer screen window of FIG. 63). Service definitions and instructions for services relate to work orders generated by an entity using the global exchange services. Services provide a link between a work order and an associated invoice. In exemplary embodiments, the services feature enables an entity to directly transfer work order services to a corresponding invoice (see, e.g., computer screen windows of FIGS. 64-69).

Many other features are available via the global exchange services as shown in the computer screen windows of FIGS. 70-76. FIGS. 70-73 provide a means for generating alerts for selected entities. FIGS. 74-77 illustrate an electronic file cabinet feature of the global exchange services. The electronic file cabinet feature provides the capability to index any type of information items related to a particular order. These items can be printed and/or transmitted to other service entities (or non-service entities, if desired). The electronic file cabinet feature further enables users to caption photos (e.g., via data or embedded pixels), as well as store, display, and communicate any type of object or file (e.g., via electronic envelope of FIG. 76) as shown and described in FIGS. 74-77. It will be understood that these features described above are provided for illustrative purposes and are not to be construed as limiting in scope.

At step 314, hub communications among selected exchange service entities are enabled via, in part, the administrative permissions established from step 310. Enabling communications provides the ability for an entity to utilize the global exchange services (e.g., client/vendor setup, modification, removal; creating pricing/service fees; grouping entities by geography, etc.) and to communicate with other entities in the communications hub. The communications may be facilitated, e.g., via an IP address assigned to an entity which is network enabled.

As described above, the invention can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for implementing global exchange services, comprising:
establishing a network-based communications hub for exchange service entities via a common user interface, including:
classifying the exchange service entities by client and client vendor;
determining a subscription status identifier for the client and the least one client vendor;
grouping the client and at least one client vendor by geography;
specifying access and capability privileges for each of the exchange service entities; and
establishing accounting preferences, service fees, and service definitions and instructions for services provided by the exchange service entities; and
enabling communications among selected exchange service entities via administrative permissions established resulting from the access and capability privileges specified for each of the exchange service entities.

2. The method of claim 1, wherein the subscription status identifier identifies:
registered service entities that are provided access to and receive one or more services of the global exchange services; and
non-registered service entities that provide services to registered service entities and do not receive the services of the global exchange services.

3. The method of claim 1, wherein establishing account preferences includes:
specifying a manner of applying and posting payments received from a client vendor;
posting a payment by a work order identifier;
adjusting line entries of an accounting journal for an invoice; and
tracking an unpaid balance for a vendor and automatically generating payment for the unpaid balance.

4. The method of claim 1, wherein establishing service fees includes creating a customized pricing table using a price code specifying service fee amounts for each service provided.

5. The method of claim 1, wherein establishing service definitions includes:
specifying a work order description, invoice description, price code for services, and service types; and
linking each entered work order with an associated invoice.

6. The method of claim 1, further comprising:
linking a work order to files associated with the work order, the files including at least one of a(n):
image;
facsimile;
spreadsheet;
streaming video; and
audio.

7. The method of claim 1, wherein the global exchange services comprise property preservation services, wherein the service entities include one or more of a(n): mortgage lender;
loan servicing entity;
insurance company;
contract property preservation service provider; and
contract property preservation inspection service provider; and
the services include at least one of:
changing locks:
removing trash;
carpentry;
lawn care; and
winterization.

8. A system for implementing global exchange services, comprising:
a host system; and
a global exchange services application executing on the host system and including a common user interface, the global exchange services application implementing a method, the method comprising:
establishing a network-based communications hub for exchange service entities via the common user interface, including:
classifying the exchange service entities by client and client vendor;
determining a subscription status identifier for the client and at least one client vendor;
grouping the client and at the least one client vendor by geography;
specifying access and capability privileges for each of the exchange service entities; and
establishing accounting preferences, service fees, and service definitions and instructions for services provided by the exchange service entities; and
enabling communications among selected exchange service entities via administrative permissions established resulting from the access and capability privileges specified for each of the exchange service entities.

9. The system of claim 8, wherein the subscription status identifier identifies:
registered service entities that are provided access to and receive one or more services of the global exchange services; and
non-registered service entities that provide services to registered service entities and do not receive the services of the global exchange services.

10. The system of claim 8, wherein establishing account preferences includes:
specifying a manner of applying and posting payments received from a client vendor;
posting a payment by a work order identifier;
adjusting line entries of an accounting journal for an invoice; and
tracking an unpaid balance for a vendor and automatically generating payment for the unpaid balance.

11. The system of claim 8, wherein establishing service fees includes creating a customized pricing table using a price code specifying service fee amounts for each service provided.

12. The system of claim 8, wherein establishing service definitions includes:
specifying a work order description, invoice description, price code for services, and service types; and
linking each entered work order with an associated invoice.

13. The system of claim 8, wherein the global exchange services application further performs:
linking a work order to files associated with the work order, the files including at least one of a(n):
image;
facsimile;
spreadsheet;
streaming video; and
audio.

14. A computer program product for implementing global exchange services, the computer program product including instructions for causing a computer to implement a method, comprising:
establishing a network-based communications hub for exchange service entities via a common user interface, including:
classifying the exchange service entities by client and client vendor;
determining a subscription status identifier for the client and the least one client vendor;
grouping the client and at least one client vendor by geography;
specifying access and capability privileges for each of the exchange service entities; and
establishing accounting preferences, service fees, and service definitions and instructions for services provided by the exchange service entities; and
enabling communications among selected exchange service entities via administrative permissions established resulting from the access and capability privileges specified for each of the exchange service entities.

15. The computer program product of claim 14, wherein the subscription status identifier identifies:
registered service entities that are provided access to and receive one or more services of the global exchange services; and
non-registered service entities that provide services to registered service entities and do not receive the services of the global exchange services.

16. The computer program product of claim 14, wherein establishing account preferences includes:
specifying a manner of applying and posting payments received from a client vendor;
posting a payment by a work order identifier;
adjusting line entries of an accounting journal for an invoice; and
tracking an unpaid balance for a vendor and automatically generating payment for the unpaid balance.

17. The computer program product of claim 14, wherein establishing service fees includes creating a customized pricing table using a price code specifying service fee amounts for each service provided.

18. The computer program product of claim 14, wherein establishing service definitions includes:
specifying a work order description, invoice description, price code for services, and service types; and
linking each entered work order with an associated invoice.

19. The computer program product of claim 14, further comprising instructions for implementing:
linking a work order to files associated with the work order, the files including at least one of a(n):
image;
facsimile;
spreadsheet;
streaming video; and
audio.

20. The computer program product of claim 14, wherein the global exchange services comprise property preservation services, wherein the service entities include one or more of a(n):
mortgage lender;
loan servicing entity;
insurance company;
contract property preservation service provider; and
contract property preservation inspection service provider; and
the services include at least one of:
changing locks:
removing trash;
carpentry;
lawn care; and
winterization.
